(19) United States
(12) Patent Application Publication
(10) Pub. No.: US 2026/0157902 A1
(43) Pub. Date: Jun. 11, 2026

(54) MOBILE PATIENT CONTAINMENT CHAMBER SYSTEM AND METHOD

(71) Applicant: Carecubes Inc., San Francisco, CA (US)

(72) Inventors: Jake LaCore, San Francisco, CA (US); Carrie Davis, San Francisco, CA (US); Patricia Lord, San Francisco, CA (US); David Brett-Major, San Francisco, CA (US); James Lawler, San Francisco, CA (US); Jana Broadhurst, San Francisco, CA (US)

(21) Appl. No.: 19/413,375

(22) Filed: Dec. 9, 2025

Related U.S. Application Data
(60) Provisional application No. 63/729,857, filed on Dec. 9, 2024.

(51) Int. Cl. A61G 10/02; A61G 1/02

(52) U.S. Cl. CPC A61G 10/023; A61G 1/02

(57) ABSTRACT

A method that includes assembling the containment chamber by assembling an architecture and attaching an enclosure to the architecture, the enclosure defining a chamber via a plurality of walls, the attaching causing suspension of the plurality of walls into an expanded state. The method further includes disposing the containment chamber on a mobile unit; disposing a patient in the containment chamber and on the mobile unit; configuring the containment chamber from the expanded state to a collapsed state; and moving the patient from the first location to the second location includes moving the patient through a door or opening that the containment chamber on the mobile unit would be inoperable to fit through in the expanded state, but is operable to fit through in the collapsed state, and while the containment chamber remains operable to isolate the patient within an internal cavity of the chamber while in the collapsed state.

### CROSS-REFERENCE TO RELATED APPLICATIONS

This application is a non-provisional of and claims the benefit of U.S. patent application Ser. No. 63/729,857, filed Dec. 9, 2024, entitled “MOBILE PATIENT CONTAINMENT CHAMBER SYSTEM AND METHOD,” with attorney docket number 0116331-002PR0. This application is related to US non-provisional patent application Ser. No. 17/459,564, filed Aug. 27, 2021 entitled “ISOLATION ROOM SYSTEMS AND METHODS,” with attorney docket number 0116331-001US0, which claims the benefit of U.S. Provisional Application No. 63/071,830, filed Aug. 28, 2020, entitled “Negative Pressure Isolation Unit for Rapid Deployment During a Pandemic,” with attorney docket number 0116331-001PR0. These applications are hereby incorporated herein by reference in their entirety and for all purposes.

### BRIEF DESCRIPTION OF DRAWINGS

FIG. 1 is a side view of a containment chamber in accordance with an embodiment.

FIG. 2 illustrates the embodiment of FIG. 1 with roof support poles removed to reduce the height of the containment chamber.

FIG. 3 is a rear side view of a containment chamber in accordance with an embodiment.

FIG. 4 is a front side view of a containment chamber in accordance with an embodiment.

FIG. 5 is a perspective view of a support architecture in accordance with an embodiment.

FIG. 6 is a side view of a containment chamber in accordance with an embodiment.

FIG. 7 illustrates the embodiment of FIG. 6 with roof support poles removed to reduce the height of the containment chamber.

FIG. 8a is a top view of a base of a support architecture in accordance with an embodiment.

FIG. 8b is a side view of the base of a support architecture in accordance with an embodiment.

FIG. 9 is a perspective view of a containment chamber in accordance with an embodiment.

FIG. 10 is a perspective view of a containment chamber in accordance with an embodiment.

FIG. 11 is a perspective view of a containment chamber in accordance with an embodiment.

FIG. 12 is a rear side view of a containment chamber in accordance with an embodiment.

FIG. 13 is a front side view of a containment chamber in accordance with an embodiment.

FIG. 14 is a top view of a containment chamber in accordance with an embodiment.

FIG. 15 illustrates the configuration of one embodiment of a pass-through.

FIGS. 16a, 16b, 17a and 17b illustrate an embodiment of a pass-through unit.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

Bio-secure isolation rooms can be key pieces of equipment that can provide a safe working environment when treating patients with infectious diseases or people under investigation for having an infectious disease. In various embodiments, such an isolation room can comprise one or more chambers that are sealed relatively air-tight and a fan or air handling system that pulls air from at least one of the one or more chambers, filters the air and directs the air to a location external from the isolation room. The negative pressure created in the isolation room can allow for small leaks in the isolation room system by drawing air into the room from such leaks, and therefore into the filtration system, instead of pushing possibly dangerous air out of the opening of such leaks.

Conventional bio-containment systems can be expensive and time consuming to install, making them inaccessible to areas with limited financial resources and ineffective during times of crisis when many isolation room systems need to be deployed quickly. The present disclosure presents examples of isolation room systems and methods in accordance with some embodiments that can be low cost to manufacture, safe to operate, readily transportable and rapidly deployable in times of need.

Various embodiments disclosed herein relate to a portable, negative-pressure isolation chamber system configured to safely isolate patients suspected or known to carry infectious agents, with some examples including an isolation room system that can be made of thin polymer films that can be folded and stored until it is needed. When deployed, various examples of an isolation room system can be connected to a rigid pole framework architecture, held up by a positively pressured inflatable structure, or the like. Various examples can be manufactured of thin film polymer sheets that are designed to allow the use of standard decontamination procedures such as UV, chemical, or mechanical cleaning. Some embodiments can include an external fan assembly that draws the air from inside the isolation room system through a filtration system adequate enough to provide removal of harmful particles such as droplets, bodily fluids, airborne infectious particles, and the like.

In various examples, it can be desirable for such an isolation room (e.g., a patient isolation unit (PIU), patient containment chamber, or the like) to be portable or mobile. For example, in various embodiments, an isolation room can be configured to be disposed on a stretcher, gurney, or the like (e.g., a foldable roll-in stretcher).

In various embodiments, the isolation room can be configured to go from a smaller configuration to a larger configuration and back to a smaller configuration for transporting by land, air, sea or the like. For example, in various embodiments, it can be desirable to expand and collapse the isolation room system without removing the patient from the chamber of the isolation room system. In various embodiments, it can be desirable to expand and collapse the isolation room system while maintaining negative pressure, without needing to remove the patient from the chamber.

The isolation chamber system in various embodiments can include a support architecture configured to hold a flexible enclosure defining a containment volume or chamber, in which a patient and associated medical equipment can be positioned for transport or treatment. The support structure can be assembled from modular or collapsible components, enabling the system to be rapidly deployed in clinical or field settings and easily collapsed for storage or transport. The enclosure can be formed from flexible polymer materials and can incorporate various access points, pass-through interfaces, filtration elements, and visibility features to facilitate patient care while maintaining environmental isolation.

In some embodiments, the architecture includes a base assembly configured to support the weight of a patient, with vertical poles extending upward to define the general geometry of the enclosure. Top-of-wall beams can interconnect the vertical poles and establish the upper perimeter of the chamber, and one or more roof support poles may extend across or above the enclosure to support a flexible roof wall. The vertical poles may have differing lengths to establish a sloped roof profile, allowing increased headroom at one end of the chamber. In certain embodiments, the structure may be configured to allow inclination of the patient's head by up to 90 degrees while maintaining adequate clearance and sealing.

The support architecture can be designed to be collapsible, extendable, or foldable, using telescoping segments, hinged joints, and tool-less locking mechanisms such as push-button detent pins. This can allow the chamber to transition between an expanded operational configuration and a collapsed configuration suitable for transport within ambulances, helicopters (e.g., Airbus H135), or fixed-wing air ambulances. The flexible enclosure can be affixed to the structure using various couplings, such as bungee ties, zippers, magnets, or hook-and-loop fasteners. In various embodiments, the system can be collapsed or expanded without removing the patient from the chamber, allowing for dynamic adjustments during care or transport while maintaining negative pressure.

The enclosure can include a plurality of flexible walls that can be configured to include doors, glove interfaces, pass-throughs, and a peripheral coupling that allows the upper and lower portions of the chamber to be selectively opened or sealed. The peripheral coupling can take various forms, including zippers, and may follow slanted, curved, or horizontal paths along the chamber. In some embodiments, the coupling can open fully to allow for patient loading or partially for selective access. The chamber can be sized to accommodate a patient up to 6′8″ tall and weighing 300 lbs and may include reinforced seams and structural supports to handle such loads.

In various embodiments, access to the chamber interior can be facilitated through various interfaces, including glove ports and elongated sleeves that permit manipulation of medical instruments or patient contact without breaking the seal. Additionally, pass-throughs configured for clinical tubing, monitoring equipment, or power lines may be integrated into the walls, with resealable and interchangeable pass-through units that preserve airtightness. Some embodiments may also include emergency breach panels that can be rapidly opened and resealed to permit urgent access to the patient's airway or other critical areas.

An air filtration system may be integrated into or mounted to the enclosure, with intake and exhaust filters capable of maintaining a negative-pressure environment compliant with CDC guidelines (e.g., 15 or more air exchanges per hour). The system may incorporate HEPA or MERV-rated filters, with the ability to generate and sustain pressure levels below −2.5 Pascals. In some embodiments, the filtration system may include redundant sealing mechanisms, sedimentation filters, volatile anesthetic filters, or integrated pressure monitoring sensors. Visual indicators of pressure status, including LEDs or mechanical flags, may be positioned for visibility during procedures near the patient's head.

The enclosure in various examples can be configured to support continuous operation for at least 48 hours, with materials and components selected to withstand repeated manipulation, environmental stress, and cleaning with common disinfectants. The flexible polymer walls may include anti-fog or abrasion-resistant coatings, and couplings, glove interfaces, and pass-throughs may be designed to tolerate at least 30 practitioner interactions or 10 full component replacement cycles without degradation. The chamber may also include modular internal and external pockets configured to store medical supplies such as suction canisters, with adjacent pass-throughs allowing tubing to pass into or out of the chamber while preserving sealing.

The chamber's dimensions can be configured in various embodiments for compatibility with standard transport systems and clinical environments, with widths, lengths, and heights that allow fitting through doorways and within confined compartments, while still supporting patient care. The containment volume can vary between expanded and collapsed configurations and may be configured to maintain sufficient airflow, humidity, and CO2 levels for extended patient occupancy. Weight considerations can be addressed in some examples through the use of lightweight materials, with some embodiments configured to weigh less than 45 pounds in total and to be assembled in less than 10 minutes using at most one tool.

Accordingly, various embodiments can provide a versatile, mobile isolation unit that can provide negative-pressure patient containment across various healthcare, emergency, and transport environments, while supporting clinical intervention through integrated access points and interfaces, maintaining biosecure integrity, and facilitating rapid setup and redeployment.

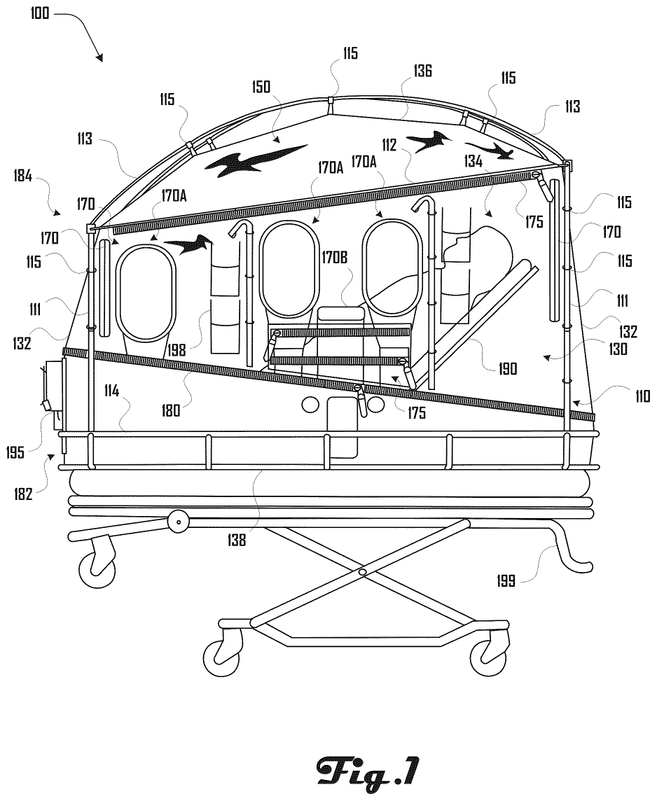

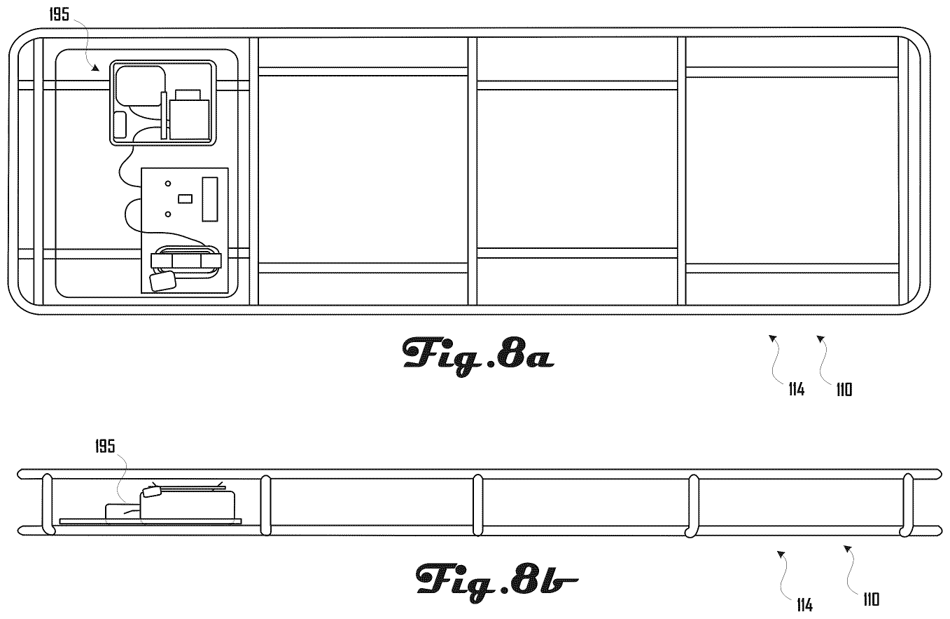

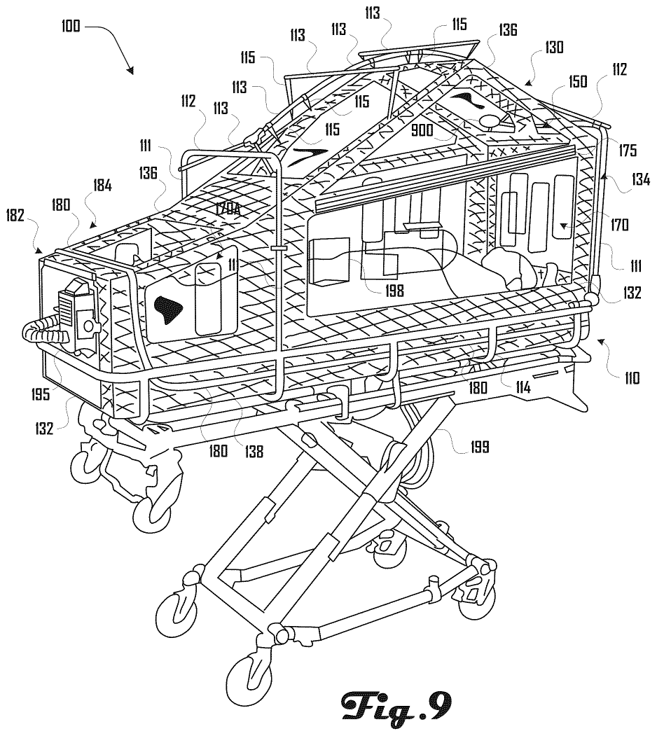

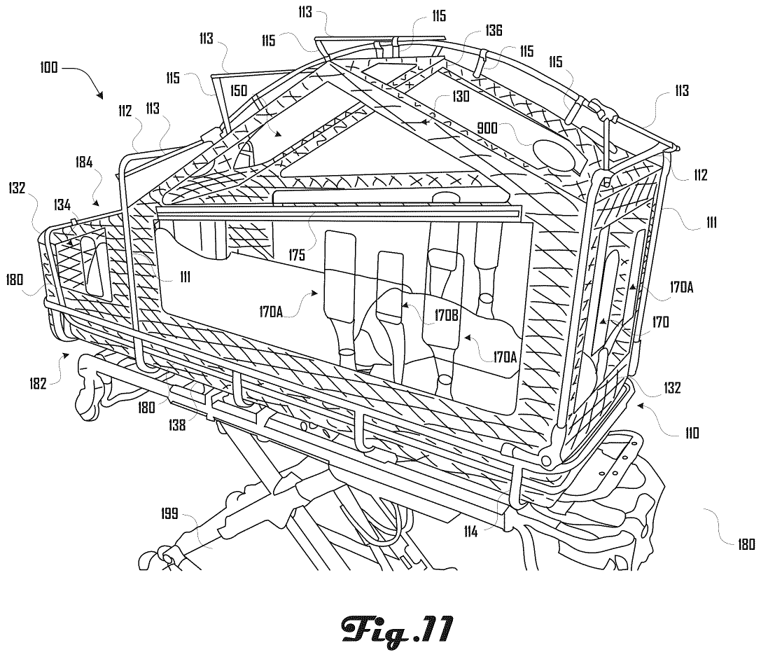

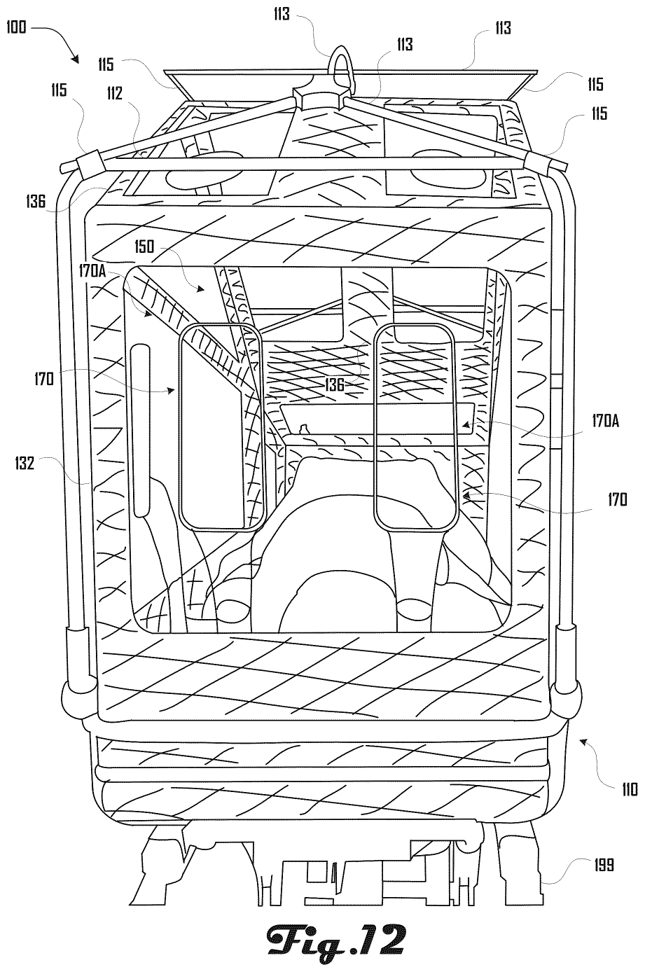

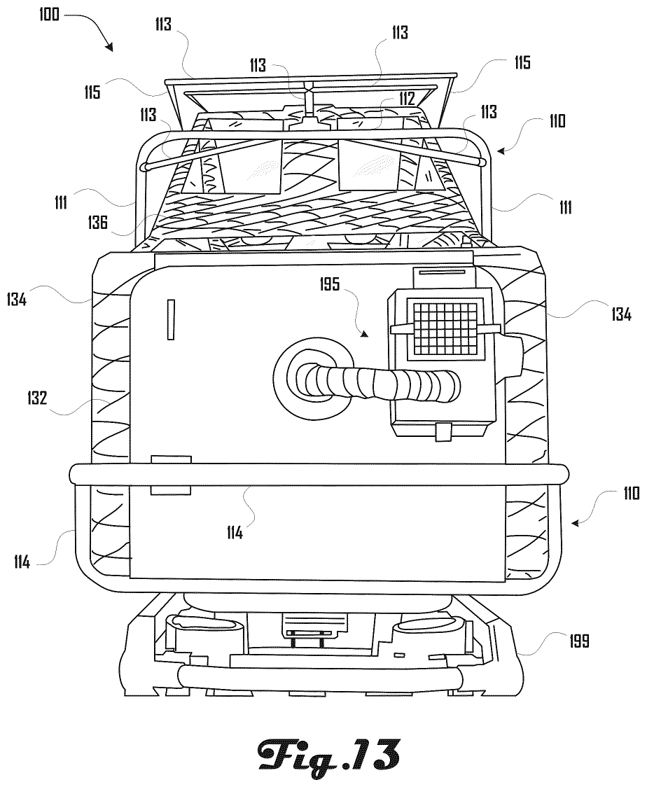

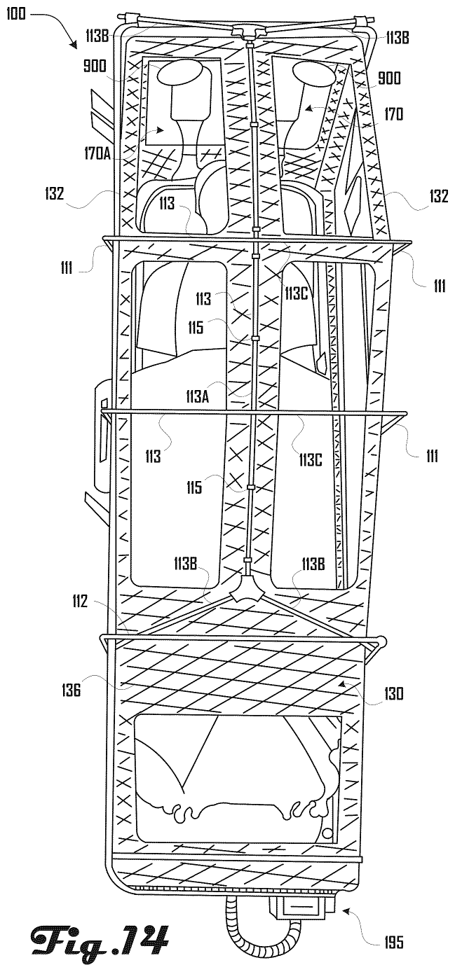

Turning to FIGS. 1-14, embodiments of a containment chamber 100 are illustrated that include an architecture 110 that supports a plurality of walls 130, which in some examples can comprise transparent or translucent flexible polymer sheets such as polyvinyl chloride (PVC), high-density polyethylene (HDPE), vinyl, thermoplastic urethane (TPU) or the like. The walls 130 can define a chamber 150 and can include elements such as one or more interfaces 170, pass-throughs 175, peripheral coupling 180, doors 185, and the like. The one or more chambers 150 can be configured to hold various medical, hygiene, other equipment such as a bed 190, and the like.

As shown in the examples of FIGS. 1-5, the architecture 110 can comprise a plurality of rigid poles that can include a plurality of vertical poles 111 that define corners of the containment chamber 100 with top-of-wall beams 112, and roof support poles 113 that support a roof structure. In various embodiments, the vertical poles 111 can be coupled to a base assembly 114. The architecture 110 can be made of various suitable materials such as metal, plastic, wood, or the like. While some embodiments of the architecture 110 include rigid poles, pipes, or the like, further embodiments can include an architecture 110 defined in various other suitable ways, including via inflatable structures.

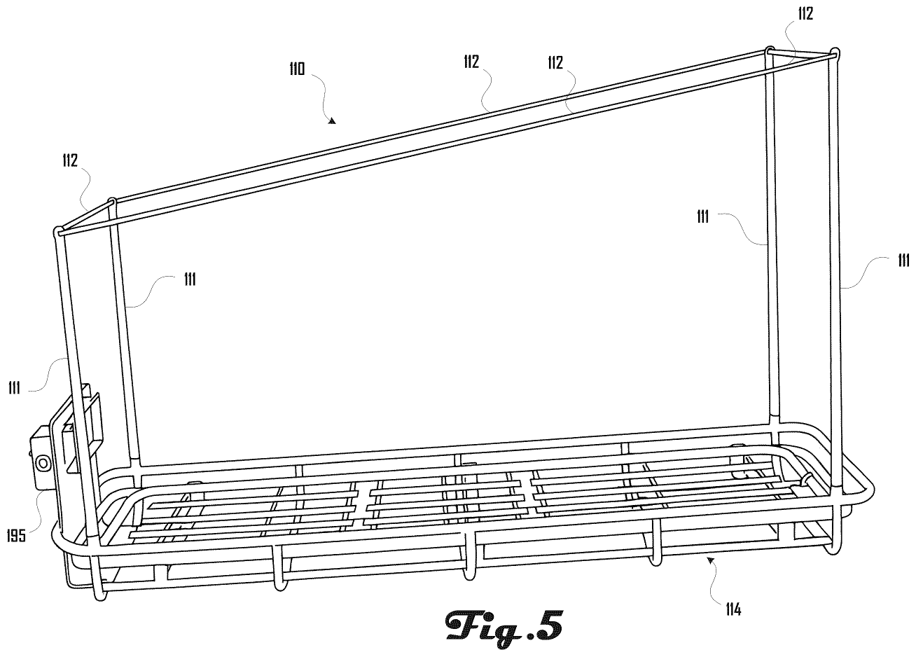

In various embodiments, the base assembly 114 can comprise a rigid support platform configured to receive and support the weight of a user positioned within the containment chamber 100. As shown in FIG. 5, for example, the base assembly 114 can include a perimeter frame formed from tubular metal members arranged in an elongated, generally rectangular shape. The perimeter frame can provide structural rigidity and define the outer boundary of the support surface. Within the perimeter frame, a series of transverse support bars or slats can extend across the width of the assembly to form a load-bearing deck on which a user may lie. The base assembly 114 can further include a plurality of lower cross-members or longitudinal rails positioned beneath the support surface to distribute loads and maintain the overall stiffness of the platform.

The base assembly 114 can also serve as the foundation for the vertical poles 111 and an external flexible enclosure. For example, opposing corners and/or sides of the perimeter frame can include upward-facing sockets, brackets, or receivers configured to releasably couple with the vertical poles 111 to support a surrounding flexible polymer enclosure that defines the plurality of walls 130. In some embodiments, the base assembly 114 may additionally incorporate mounting structures at one end to interface with a support stand, mobility unit, or medical equipment system. Collectively, the frame, support deck, and pole-receiving structures can allow the base assembly 114 to function as a patient litter while providing an integrated structural interface for the containment architecture.

In various embodiments, the vertical poles 111, the top-of-wall beams 112, and one or more roof support poles 113 can together define the perimeter and upper geometry of the containment chamber 100. As shown in the example of FIG. 5, the vertical poles 111 can be rigid linear members that extend upward from the base assembly 114 and establish the height and a general envelope of the containment chamber 100. In some embodiments, the vertical poles 111 coupled to one longitudinal side of the base assembly 114 can have a first length, while the vertical poles 111 positioned along the opposite longitudinal side can have a second, greater length. This difference in height of the vertical poles 111 can create a sloped upper profile that creates a greater height in one end of the containment chamber 100, which can be desirable for allowing a patient to sit up in that end of the containment chamber 100. Each vertical pole 111 may be mounted to the base assembly 114 in various suitable ways using element such as sockets, brackets, clamps, welded interfaces, or the like, that rigidly retain the lower ends of the poles in an upright orientation.

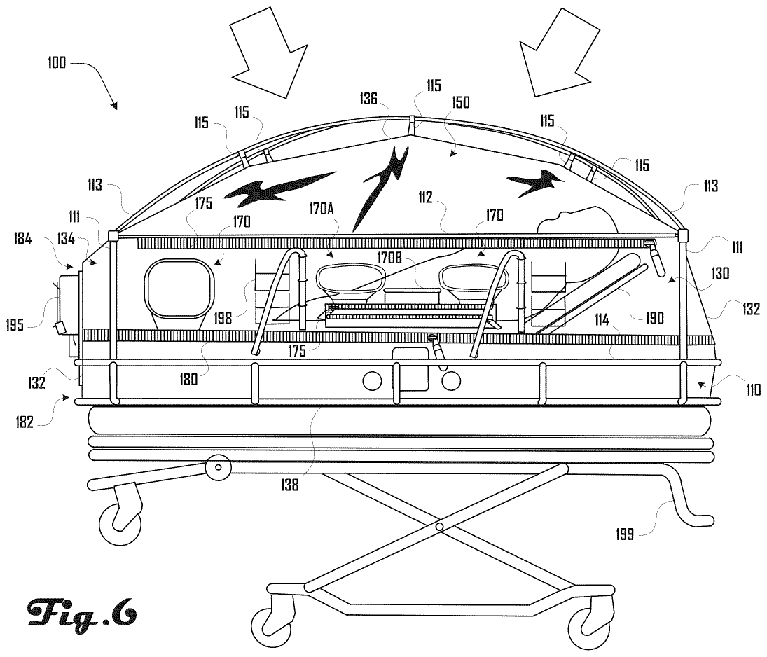

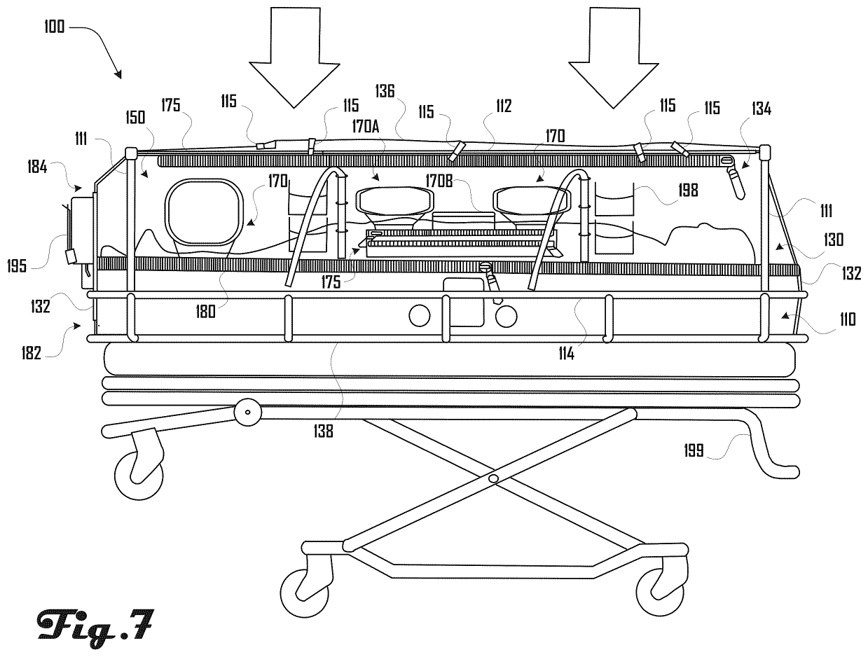

The top-of-wall beams 112 in various examples can extend horizontally between the upper ends of the vertical poles 111, thereby interconnecting adjacent poles and forming the top frame of the containment chamber 100. In some embodiments, opposing top-of-wall beams 112 can be parallel to each other but oriented at a downward slope from the taller vertical poles 111 to the shorter vertical poles 111, resulting in a pitched or inclined upper support structure such as shown in FIGS. 1-5 or a horizontal upper support structure as shown in the example of FIGS. 6 and 7. These top-of-wall beams 112 may be rigid tubular members mechanically coupled to the vertical poles 111 via corner fittings, clamps, welded joints, integrated receiving sockets, or the like, formed in the ends of the beams 112. The length differential of the vertical poles 111 in various embodiments directly establishes the angle of inclination of the top-of-wall beams 112.

In some embodiments, the roof support poles 113 can be coupled across the upper portion of the structure to provide additional support for the plurality of walls 130 as discussed in more detail herein. The roof support poles 113 may be rigid or semi-flexible arcuate members that extend between, or slightly above, the top-of-wall beams 112. These roof support poles 113 can be received in upward-facing brackets or couplers positioned along the upper frame, or they may mechanically interface with corner fittings that also join the top-of-wall beams 112 to the vertical poles 111. When the roof support poles 113 are tensioned or arched into position, they can create a raised or sloped profile complementary to the slope established by the top-of-wall beams 112, enabling proper clearance and maintaining the shape of the plurality of walls 130 as discussed herein.

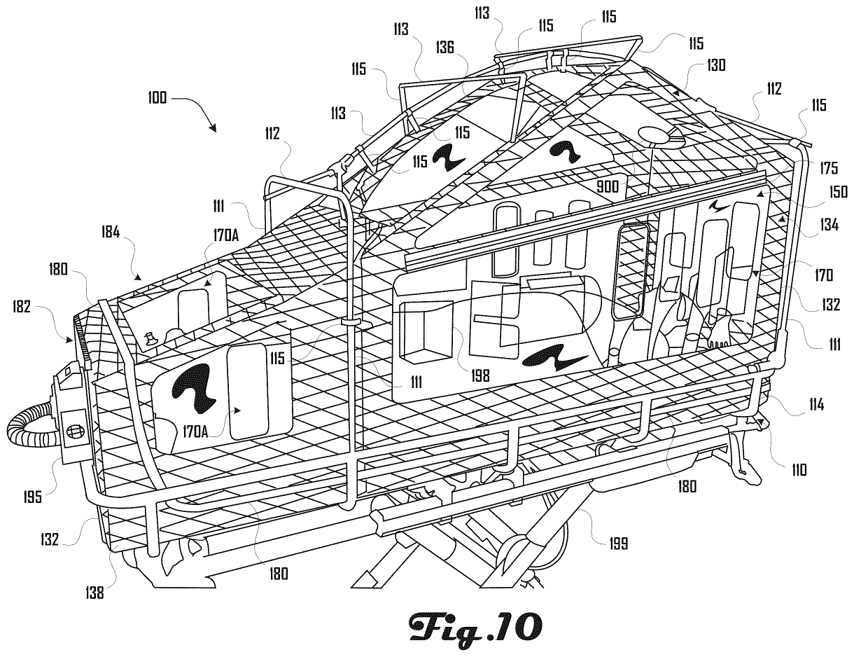

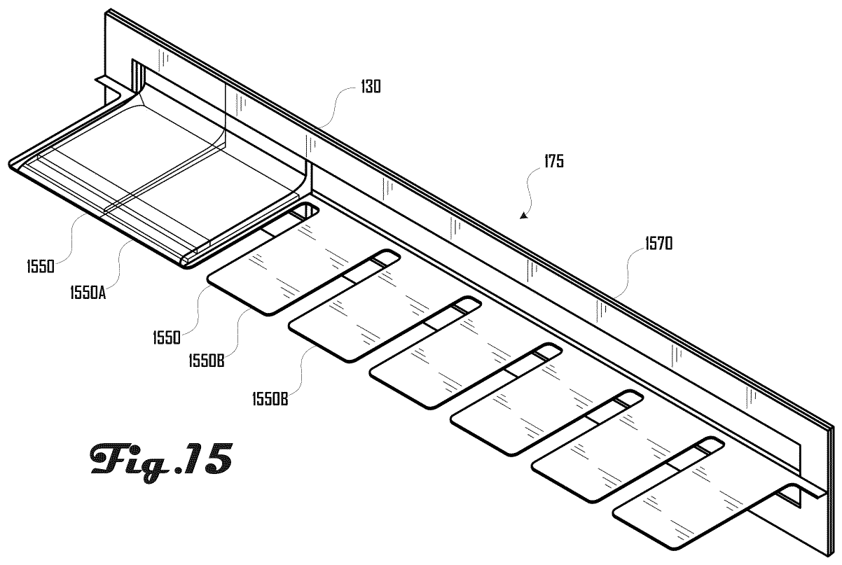

As shown in the example embodiments of FIGS. 9-14, in some embodiments (see e.g., FIG. 14), roof support poles 113 can include a central roof support pole 113A that extends over the roof wall(s) 136 with a pair of roof support pole arms 113B that extend from opposing ends of the central roof support pole 113A and couple with top-of-wall beams 112. Additionally, the roof support poles 113 can include a first and second roof support bar 113C that are coupled to the central roof support pole 113A and disposed perpendicular to the main axis of the central roof support pole 113A. Couplings 115 at the ends of the roof support bars 113C can be attached to the roof wall(s) 136 and can hold the walls 130 up. Additionally, a plurality of couplings 115 can extend from the central roof support pole 113A and be attached to the roof wall(s) 136 to further hold the walls 130 up.

Collectively, the vertical poles 111, top-of-wall beams 112, and roof support poles 113 can form an integrated rigid frame that defines the geometric boundaries of the containment chamber 100, can support flexible plurality of walls 130, and can provide sufficient structural integrity for safe isolation of a user resting on the underlying base assembly 114.

In various embodiments, the architecture 110, or portions thereof, can be configured to be disassembled, collapsible, or extendable to facilitate transport, storage, and rapid deployment in the field. For example, one or more of the vertical poles 111, top-of-wall beams 112, or roof support poles 113 can be formed from multiple segments that are selectively detachable from one another using mechanical couplings such as threaded connectors, push-button locking pins, bayonet-style couplers, friction-fit ferrules, or hinged joints. In such embodiments, the structural members can be separated into compact sections that can be stowed alongside the base assembly 114 or within a dedicated carrying case. When reassembled, the joints can rigidly lock the components into fixed alignment to restore the full structural integrity of the architecture 110.

In some embodiments, one or more of the structural poles can be telescoping members that include nested tubular segments capable of extending or retracting relative to each other. A telescoping vertical pole 111, for example, may comprise two or more coaxial tubes that are slidably received within one another and that can be adjusted to achieve different heights depending on operational requirements. Locking collars, spring-biased detent pins, twist-lock mechanisms, or compression clamps may be used to secure the telescoping segments at the desired extended length. Similarly, top-of-wall beams 112 or roof support poles 113 may be configured as extendable elements to accommodate variations in the size or shape of the containment chamber 100, to increase the roof pitch, or to support alternative enclosure materials.

Further embodiments can include foldable or hingedly connected portions of the architecture 110. For example, one or more corner joints between vertical poles 111 and top-of-wall beams 112 can incorporate hinge mechanisms that allow the upper frame to fold inward when the containment unit is not in use. Likewise, roof support poles 113 may be configured as flexible or segmented rods that collapse under controlled bending or can be separated into multiple sections by disconnecting internal shock cords. These collapsible features of some examples can allow the entire architecture 110 to be rapidly collapsed into a reduced footprint without requiring complete disassembly.

In various embodiments, the flexible roof support poles 113 can be formed from materials that provide both structural rigidity and elastic deformability, such as fiberglass composites, spring steel, carbon-fiber composites, or flexible polymer-reinforced tubing. These roof support poles 113 in some examples can be configured as multi-segment assemblies in which individual cylindrical segments are joined end-to-end by an internal elastic cord (e.g., a shock cord) that maintains the segments in tension. This construction can allow the roof support poles 113 to be easily collapsed into shorter segments for storage and transport while permitting rapid deployment in which the segments self-align and lock together to form a continuous, resilient arched member. In further embodiments, the pole segments can include ferrules, tapered couplers, or interference-fit connectors that ensure secure engagement when the roof support poles 113 are assembled and subjected to bending forces during use.

Returning to the example embodiments of FIGS. 1-4, the walls 130 of the containment chamber 100 can be joined to and supported by the architecture 110 in various suitable ways including via a plurality of couplings 115, which in some examples can include bungee ties, zip ties, ropes, magnets, hook and loop tape (e.g., Velcro), adhesives, welds, loops, hooks, snaps, or the like. In various embodiments, the containment chamber 100 or portions thereof can have a polyhedron shape with walls 130 that include end-walls 132, sidewalls 134, roof walls 136, and a floor wall 138. While various embodiments of a containment chamber 100 can have a polyhedron shape portion as in FIGS. 1-4, further embodiments can include any suitable shapes or configurations, including curved or circular walls 130, so the present examples should not be construed to be limiting on the wide variety of other morphologies of a containment chamber 100 that are within the scope and spirit of the present disclosure.

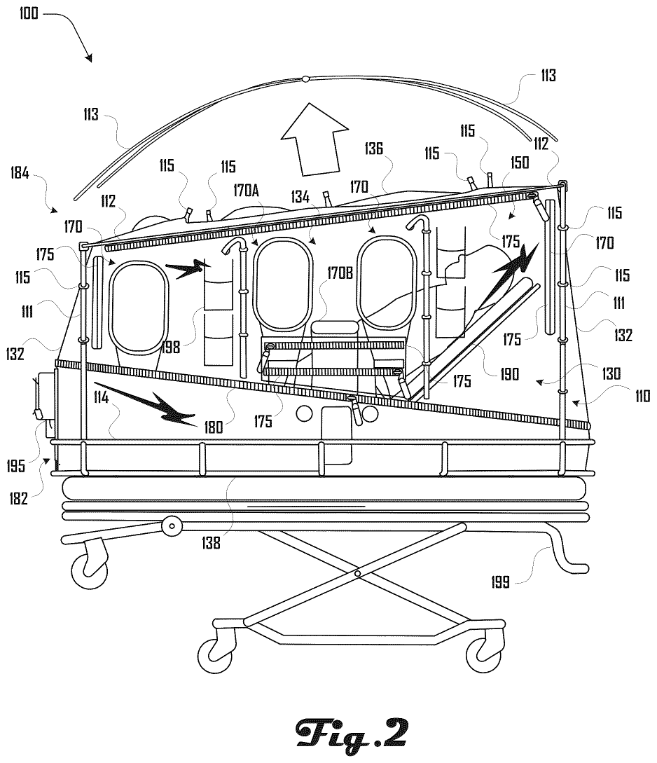

In various embodiments, the roof support poles 113 can be removably coupled to the roof wall 136 and to the upper portion of the architecture 110 such that the roof structure of the containment chamber 100 can transition between an expanded, tensioned state and a collapsed, low-profile state. As shown in the examples of FIG. 1, when the roof support poles 113 are installed, they can extend in an arched configuration between opposing sides of the architecture 110, thereby lifting and tensioning the roof wall 136 into its raised canopy shape. In FIG. 2, the roof support poles 113 are shown having been removed, allowing the roof wall 136 to collapse downward along the top-of-wall beams 112. In various embodiments, removal of the roof support poles 113 can be achieved by disengaging one or more couplings 115 that mechanically or elastically link the poles to the roof wall 136 and/or to the upper frame.

In some embodiments, the lower or end portions of the roof support poles 113 can be received in sockets, clips, ferrules, or cradles positioned at or near the upper corners of the vertical poles 111 or the ends of the top-of-wall beams 112. These interfaces can allow the roof support poles 113 to be lifted upward or laterally disengaged without requiring tools. The roof support poles 113 may also be connected to the roof wall 136 at various intermediate points along their length through couplings 115 configured as bungee ties, elastic loops, fabric sleeves, snap clips, hook-and-loop straps, or zip ties. During disassembly, a user can sequentially de-couple these couplings 115 from the roof support poles 113, after which the roof support poles 113 can be withdrawn entirely from the containment chamber 100 as shown in the example of FIG. 2. Once the roof support poles 113 are removed, the roof wall 136 can fold or drape downward under gravity, allowing the entire structure to collapse into a compact form suitable for transport or storage.

In further embodiments, couplings 115 may be permanently affixed to the roof wall 136 so that they remain attached to the enclosure material even when the roof support poles 113 are removed. For example, the couplings 115 can be sewn, welded, heat-fused, adhered, or mechanically fastened to flexible polymer material of the roof wall 136. Fabric loops or sleeves may be stitched directly into the material to create channels that receive the roof support poles 113 during assembly. Alternatively, plastic or metal clips may be integrated into reinforced patches affixed to the roof wall 136. In some embodiments, magnets or hook-and-loop patches may be bonded to the roof wall 136 and configured to releasably capture corresponding magnetic or fabric-covered features on the roof support poles 113. These permanently affixed couplings of various embodiments can allow the roof wall 136 to remain properly indexed and aligned relative to the poles during assembly while ensuring that disassembly is quick and intuitive.

In certain embodiments, the roof support poles 113 themselves may be flexible, segmented, or collapsible (e.g., elastic-corded poles), further enhancing portability. Such poles can be removed from the couplings 115 and then collapsed into smaller segments for stowage. The combination of removable roof support poles 113 and permanently attached couplings 115 of various embodiments can allow the roof wall 136 to be rapidly transitioned between a fully expanded operational state and a collapsed state suitable for compact storage or field deployment. In various embodiments the roof support poles 113 can be coupled at a central location where the support poles 113 cross. While some embodiments include a first and second support pole 113, further embodiments can include a unitary structure having four pole segments extending outward from a central location.

A patient can be introduced to the containment chamber 100 for isolation in various suitable ways. For example, in some embodiments the walls 130 can include a peripheral coupling 180 (e.g., a zipper) that fully extends around the perimeter of the walls 130 that define the chamber 150 with the peripheral coupling 180 allowing the walls 130 that define the chamber 150 to be fully or partially separated into a bottom portion 182 and a top portion 184 such that a patient can be introduced within the chamber 150 and the peripheral coupling 180 can be closed to seal the chamber 150 and isolate the patient.

For example, in some embodiments a method of use of the containment chamber 100 can include opening the chamber 150 by partially or fully decoupling the bottom portion 182 and top portion 184 via the peripheral coupling 180, and then introducing a patient into the bottom portion 182 along with other articles like a bed 190 and then sealing the containment chamber 100 by re-coupling the peripheral coupling 180 to isolate the patient within the containment chamber 100. In some embodiments, the bottom portion 182 can be opaque and the top portion can be substantially transparent to allow providers to view and interact with the patient.

In various embodiments, the peripheral coupling 180 can include any suitable structure capable of releasably joining the top portion 184 of the chamber walls 130 to the bottom portion 182 while also maintaining an airtight or contamination-resistant seal when closed. Although a zipper is shown in the example of FIGS. 1-4, other forms of peripheral couplings 180 may be used. For instance, the peripheral coupling 180 may comprise a continuous hook-and-loop fastener track, a double-sided adhesive fastening strip, a magnetic sealing interface, one or more sliding clamp rails, a series of snap fasteners, interlocking molded plastic profiles, or a flexible tongue-and-groove joint configured to engage along the perimeter of the chamber 150. In some embodiments, the peripheral coupling 180 may include two or more parallel sealing mechanisms (e.g., a zipper combined with an internal magnetic strip or adhesive flap) to provide redundancy and improve the integrity of the contamination barrier.

As further shown in the example of FIGS. 1-4, the peripheral coupling 180 can be slanted or non-horizontal, extending along a diagonal path between the ends 132. In further embodiments, the peripheral coupling 180 can be integrated into reinforced portions of the flexible walls 130 to improve durability during repeated opening and closing. For example, an elongated reinforcement band or gasket can be heat-sealed, welded, or stitched along the coupling path, serving both as a structural backing for the coupling 180 and as a contamination-resistant barrier. Where magnetic couplings are used, the reinforcement can include embedded ferromagnetic strips aligned with corresponding magnets on the mating portion. Where clamp rails or tongue-and-groove joints are used, the reinforced regions can include rigid or semi-rigid polymer segments that provide support for the coupling interface.

While some examples can include peripheral coupling 180 can be slanted or non-horizontal, further embodiments such as shown in FIGS. 6 and 7 can include a peripheral coupling 180 that is horizontal, parallel to a floor wall 138, parallel to one or more top-of-wall beams 112, or the like. Additionally, as shown in FIGS. 9-11, in some embodiments the peripheral coupling 180 can extend linearly along the sidewalls 134 and then curve upward at a front end and extend over a roof wall 136.

In some embodiments, the peripheral coupling 180 may be configured to open only partially, such as at a specific section of the slanted seam, to allow selective access to the interior without fully de-sealing the chamber 150. In other embodiments, the peripheral coupling 180 may extend continuously around the entire perimeter, allowing the entire top portion 184 of the flexible walls 130 to be lifted away or folded back for rapid patient placement, equipment installation, or cleaning. The flexibility in how the peripheral coupling 180 is shaped and implemented can enable the containment chamber 100 to accommodate a wide range of operational environments while maintaining effective patient isolation.

To maintain isolation of the patient within the containment chamber 100 and to prevent viral, bacterial or toxic elements associated with the patient from escaping the containment chamber 100, it can be desirable for direct access to the chamber 150 (e.g., peripheral coupling 180, or the like) to only be opened to allow the patient to be isolated to enter the containment chamber 100 and not be opened again until the isolated patient is to be removed from the containment chamber 100 based on not being contagious anymore, being moved to another treatment location, or the like. In other words, to maintain a safe external environment, it can be desirable to not open the peripheral coupling 180, or the like that provide direct access to the chamber 150 such as to let doctors, nurses, directly access the patient in the containment chamber 100 or to temporarily allow a patient to leave isolation within the chamber 150.

An air filtration system 195 can be included and can meet or exceed 15 air-exchanges-per-hour (ACH) CDC guidelines for surgical procedure and delivery rooms. Some examples can include a 0.3-micron HEPA exit filter and one or more MERV intake filters that in some embodiments can be welded directly to one or more walls 130. For example, FIGS. 9-11 and 14 illustrate an example of a pair of filters 900 disposed in the roof wall 136. In some embodiments a negative pressure can be generated in the containment chamber 100 (or portions thereof such as in at least the chamber 150) of between −2.5 and −2.7 Pascals, between −2.2 and −3.0 Pascals, less than or equal to −2.2, −2.5, −2.7, −3.0, −3.5, −4.0 Pascals, or the like.

As discussed herein, embodiments can include various types of interfaces 170 that allow users on the outside of a containment chamber 100 to interface with a user and/or isolated patient within the containment chamber 100 (or vice-versa in some examples) and/or for a user in one chamber 150 to interact with a user and/or isolated patient within another separate chamber 150. Examples of interfaces 170 can include a glove interface 170A and an elongated interface unit 170B.

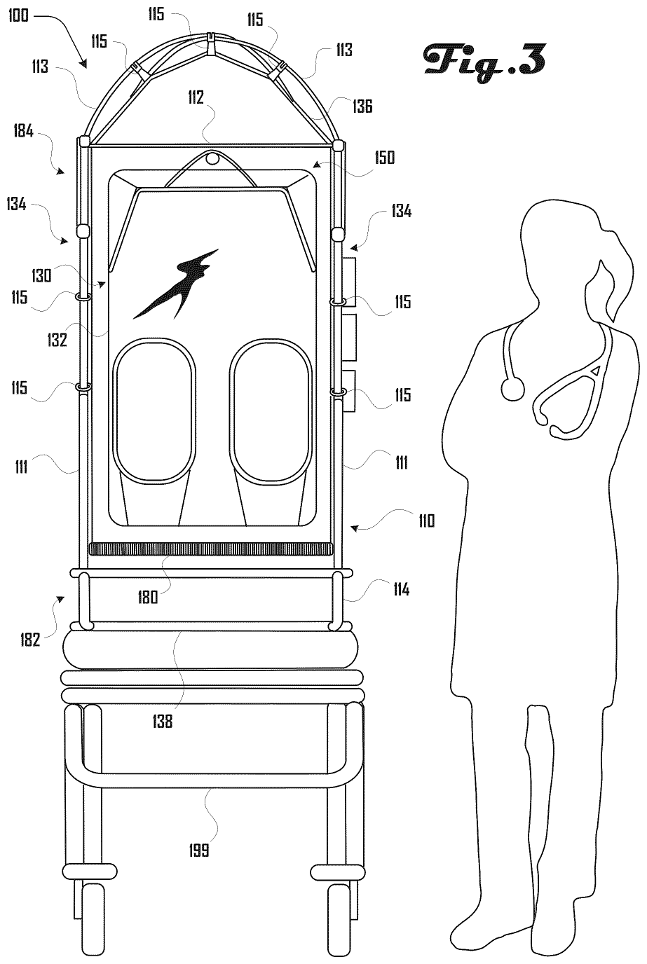

For example, FIGS. 1 and 2 illustrate an example embodiment having at least three glove interfaces 170A with three being disposed in a sidewall 134. FIG. 3 illustrates an example embodiment having at least two glove interfaces 170A on an end 132.

Additionally, another embodiment can include an interface 170 that includes an elongated interface unit 170B (e.g., similar to a glove, but without fingers, such as a cylinder) which can be used in some examples to have medical devices, or the like, inserted therein to interface with an isolated patient and to be manipulated by the pair of gloves. Accordingly, the material of such an elongated interface unit can be configured such that medical devices (e.g., stethoscope, thermometer, or the like) can operate through the material (e.g., TPU, PVC, butyl, nitrile, latex, and the like). In various embodiments, gloves can be layered over with sterile surgical gloves and/or the glove subcomponent can be replaced as needed.

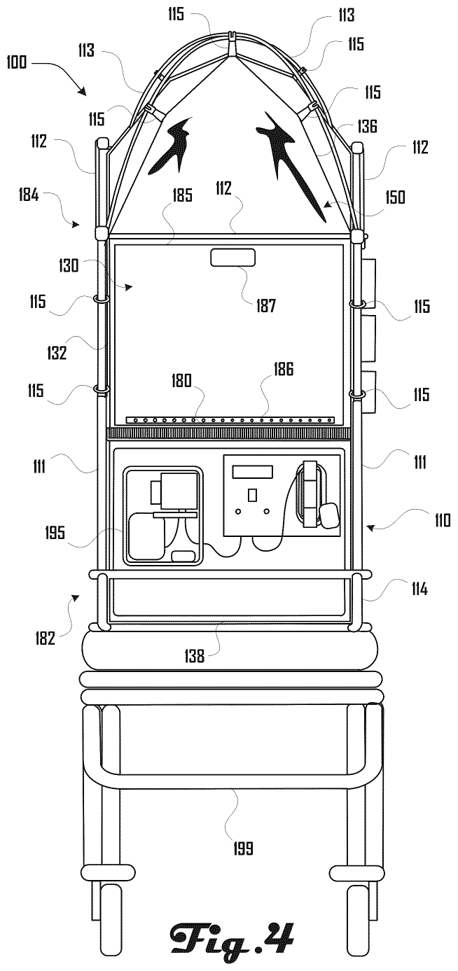

Various embodiments can include one or more pass-throughs 175 that are configured to allow various elements to extend through walls 130 of a containment chamber 100 such as an IV line, ventilator tube, monitor line, oxygen line, catheter line, communication line, power line, and the like. In some examples, a pass-through 175 can include a zipper, slit, or the like. For example, FIGS. 1 and 2 illustrate a sidewall 134 comprising a plurality of pass-throughs 175. Additionally, various embodiments can include a door 185 that allow for access direct access to the chamber 150, which may be used for emergency access to the patient, to introduce larger items that may not be able to enter via a pass-through 175, or the like. FIG. 4 illustrates an example embodiment having a door 185 disposed on an end 132 of the containment chamber 100, where the door includes a hinge 186 and a handle 187. In some examples, the door can comprise an airlock as discussed herein.

In various embodiments, the containment chamber 100 can comprise an air filtration system 195, with some embodiments including a filter disposed within a wall 130. The air filtration system 195 can include a fan that generates a negative pressure, which can in turn pull air from within the chamber 150 of the containment chamber 100 through the filter, which can purify, sanitize or disinfect the air such that the air being pulled and blown out the fan is free of viral, bacterial and/or toxic elements that may be associated with the isolated patient within the containment chamber 100.

In various examples, such a configuration can be desirable to ensure that during and after use of the containment chamber 100, no viral, bacterial and/or toxic elements are expelled. In one embodiment, such a filtration system 195 can comprise a sedimentation filter. Such a filter can comprise in some examples as two thin films joined together to create a network of chambers that allows for particulates to settle out of the air before the air moves outside the containment chamber 100.

In another embodiment, the filtration system 195 can comprise a high efficiency particulate air (HEPA) filter potted into a rigid or semi-rigid housing that can be joined to a wall 130. Such a HEPA filter can have various suitable MERV ratings for average particle size efficiency such as: MERV 1-4: 3.0-10.0 microns less than 20%; MERV 6:3.0-10.0 microns <49.9%; MERV 8:3.0-10.0 microns <84.9%; MERV 10:1.0-3.0 microns 50%-64.9%, 3.0-10.0 micron 85% or greater; MERV 12:1.0-3.0 micron 80%-89.9%, 3.0-10.0 micron 90% or greater; MERV 14:0.3-1.0 microns 75%-84%, 1.0-3.0 microns 90% or greater; MERV 16: 0.3-1.0 microns 75% or greater. Some embodiments can include filtering of the air for volatile anesthetics, heated anti-viral filters, gravity filter and the like. Various embodiments can include active and/or passive filtering systems.

The air filtration system 195 can be configured to meet or exceed a 15 air-exchanges-per-hour (ACH) CDC guidelines for surgical procedure and delivery rooms. Some embodiments can be configured to meet or exceed 5, 10, 15, 20, 25, 30 air-exchanges-per-hour (e.g., the volume of the chamber 150 can be exchanged such a number of times per hour).

In some embodiments the chamber 150 can be about 18-35 cubic feet. For example, the internal volume of the chamber 150 may be configured to fall within a range suitable for patient isolation, transport, and clinical intervention while maintaining negative-pressure performance and ergonomic accessibility. In various embodiments, the chamber 150 can have an internal volume of about 10 cubic feet, 12 cubic feet, 14 cubic feet, 15 cubic feet, 16 cubic feet, 18 cubic feet, 20 cubic feet, 25 cubic feet, 30 cubic feet, 35 cubic feet, 40 cubic feet, 45 cubic feet, 50 cubic feet, or the like, or a range between any of such example values. In further embodiments, the chamber 150 can be configured to have an internal volume of less than or equal to 10, 12, 14, 15, 16, 18, 20, 25, 30, 35, 40, or 50 cubic feet depending on operational requirements, transport constraints, or the intended clinical use environment.

In additional embodiments, the internal volume of the chamber 150 may vary between an expanded configuration and a collapsed or partially collapsed configuration. For example, in some embodiments the chamber 150 may have an expanded internal volume of about 20-50 cubic feet and a collapsed volume of about 10-25 cubic feet, with a total volume change of approximately 0.5, 1, 2, 3, 4, 5, 6, 7, 8, 9, 10, 15, or 20 cubic feet, or the like, or a range between such example values. Such volume flexibility can be desirable for accommodating patient care when fully expanded while still allowing the containment chamber 100 to fit into confined transport environments when collapsed.

Some preferred embodiments can be configured to maintain a nominal negative pressure equal to or greater than 2.5 Pa. throughout the duration of intended use; configured to maintain a nominal negative pressure equal to or less than 6.5 Pa. throughout the duration of intended use and in any volume configuration (e.g., with a roof wall 136 extended or collapsed); configured to maintain pressure below the lower limit of −2.5 Pa. with any combination of voids totaling less than or equal to 8 square inches; and configured to perform at least 12 air exchanges per hour.

In various embodiments, during use of the containment chamber 100, the internal humidity and temperature levels can be configured to stay within a normal range (+/−5% inside to outside difference) as compared to the external environment and internal CO₂ levels stay within a normal range (e.g., +/−20%) as compared to the external environment; can be configured to have a use life of at least 48 hours of continuous use; can be configured to have replaceable component points of attachment that withstand at least 10 changes without loss of integrity; can be configured to operate on standard US Power (e.g., 110 V 60 Hz obtained from a receptacle via a power cord); can be configured to have flexible shore power with high tolerance for voltage and current fluctuation; can be configured with built-in adapters for one or more common outlet types, including 220 V, 50 Hz, and the like; and configured to have the ability to run off on auxiliary battery power for at least 2 hours, 3 hours, 4 hours, or the like.

Additionally, various embodiments can comprise one or more intake filters that can allow for air intake into the containment chamber 100. Further embodiments can include any suitable number of intake filters in any suitable location(s) or intake filters can be absent in some examples.

Further embodiments of a containment chamber 100 can be configured in various suitable ways, so the specific embodiments discussed herein should not be construed as limiting on the wide variety of additional configurations that are within the scope and spirit of the present disclosure.

In various embodiments the chamber 150 can have dimensions suitable for accommodating an isolated patient while maintaining compatibility with stretcher systems, ambulance interiors, helicopter cabins, and fixed-wing air-ambulance transport. For example, the chamber 150 may have a length of less than or equal to 60, 65, 70, 72, 75, 78, or 80 inches, or a range between such example values, which in some embodiments can align with standard patient-support surfaces. In some embodiments the chamber 150 may have a width of less than or equal to 20, 22, 24, 26, 28, or 30 inches to ensure fit within common gurney rails or aeromedical transport frames. The chamber 150 may further have a height of less than or equal to 16, 18, 20, 22, 24, 26, or 30 inches in a collapsed configuration and less than or equal to 25, 28, 30, 32, 34, 36, or 40 inches in a fully expanded configuration, or a range between such example values. In additional embodiments, the height may be non-uniform (e.g., where one side of the architecture 110 is taller than the other) resulting in a sloped roof profile that increases headroom above the patient's upper body for clinical procedures. The length, width, and height of the chamber 150 may be configured in various embodiments to generate internal chamber volumes of approximately 10-50 cubic feet while maintaining transport compatibility, ergonomic access, and negative-pressure performance.

Some embodiments of a containment chamber 100 can be small and portable and configured for isolated transport of a patient from one location to another, including through standard doors (e.g., having a height of 6′6″, 6′8″, 7′0″ or 8′0″ and a width of 2′0″, 2′4″, 2′8″, 2′10″, 3′0″ or 3′6″) and configured for medical transport on a small airplane or helicopter. This can be in contrast to some embodiments that can be collapsible and mobile and configured to be brought into and erected in a hospital room or room of a building, but of a size that the erected containment chamber 100 would not be removable through standard doors because of being too large. In further examples, an erected containment chamber 100 can be too large for a typical hospital room or room of a building and can instead be configured for being erected in an outdoor environment, stadium, warehouse, or other large open location.

In various embodiments, it can be desirable for a containment chamber 100 to be collapsible into a small size (e.g., 2′×2′×4′) for storage and transportation, which can be desirable for deploying isolation room systems 100 during a pandemic or other event where many patients need to be isolated during treatment and existing facilities are not available or sufficient.

Also, various embodiments of a containment chamber 100 can be substantially completely transparent and/or translucent to allow visibility of the patient from all sides of the containment chamber 100 and some embodiments can include transparent or translucent windows, walls 130, interfaces 170, and the like to provide suitable visibility of an isolated patient. One example of this is the use of clear window sections situated strategically where a medical professional will be during procedures.

In some embodiments, the top portion 184 can be substantially completely transparent and/or translucent to allow visibility of the patient from all sides of the containment chamber 100. In some embodiments, substantially completely transparent can mean that a given portion is 99.9% transparent, 99% transparent, 98% transparent 97% transparent, 96% transparent, 95% transparent, 90% transparent, 85% transparent, 80% transparent, and the like or a range between such example values. For example, in various embodiments, various portions of the walls 130 can have elements such as seams, zippers, or the like that are not transparent, which is contemplated in various embodiments of portions that are substantially completely transparent. In some embodiments, substantially completely opaque can mean that a given portion is 99.9% opaque, 99% opaque, 98% opaque 97% opaque, 96% opaque, 95% opaque, 90% opaque, 85% opaque, 80% opaque, and the like or a range between such example values.

In various embodiments, one or more walls 130 can include internal and/or external pockets 198. In various embodiments, such pockets 198 can be configured to hold items internally within the chamber 150 or external to the chamber 150.

In various examples, it can be desirable for such an isolation room (e.g., a patient isolation unit (PIU), patient containment chamber, or the like) to be portable or mobile. For example, in various embodiments, an isolation room can be configured to be disposed on a mobile unit 199 such as a stretcher, gurney, or the like (e.g., a foldable roll-in stretcher). In various embodiments, a containment chamber 100 can be configured to fit within the profile or rails of a stretcher, gurney, or the like. For example, in some embodiments, a containment chamber 100 can have a width of less than or equal to 20, 22, 24, 26, 28, 30, 32 inches, or the like, or a range between such example values. In some embodiments, a containment chamber 100 can have a width of less than or equal to 70, 72, 74, 76, 78, 80, 82, 84 inches, or the like, or a range between such example values.

In various embodiments, a containment chamber 100 can be configured to go from a smaller configuration to a larger configuration and back to a smaller configuration for transporting by land, air, sea or the like. For example, in various embodiments, it can be desirable to expand and collapse the containment chamber 100 without removing the patient from the chamber 150 of the containment chamber 100. In various embodiments, it can be desirable to expand and collapse the containment chamber 100 while maintaining negative pressure, without needing to remove the patient from the chamber 150.

For example, as discussed herein in various embodiments one or more roof support poles 113 of a support architecture 110 can be removed from and/or collapsed on the top of the containment chamber 100 to reduce the profile of the isolation room (see e.g., 1, 2, 6 and 7). In some embodiments, one or more roof support poles 113 of the support architecture 110 can be removed or collapsed on the top of the containment chamber 100 to reduce the profile of the containment chamber 100, all while ensuring that a required or desired negative pressure is maintained within the chamber 150 of the containment chamber 100. In some embodiments, one or more vertical side poles 111 of a support architecture can be configured to be collapsed to reduce the height of the containment chamber 100. In some embodiments, one or more vertical side poles 111 of the support architecture 110 can be configured to collapse and reduce the height of the containment chamber 100, while ensuring that a required or desired negative pressure is maintained within the chamber 150 of the containment chamber 100 system during the adjustment. In other words, the containment chamber 100 can remain fully operational in an expanded state and one or more collapsed states.

In some embodiments, configuring the containment chamber 100 from the expanded state to a first collapsed state can reduce the height of the containment chamber 100 by 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, or the like, or a range between such example values. In various example, the containment chamber 100 is only configured to be changed between the expanded state to a first collapsed state and is inoperable to be further collapsed aside from being disassembled or otherwise being made inoperable for use.

In some embodiments, one or more poles of a support architecture 110 can be collapsible via any suitable system such as a telescoping nested set of poles. In some embodiments, a pair of adjacent support poles can be configured to be actuated via a single button. For example, the poles can be locked in position via a push-button locking mechanism, telescopic tube lock, or the like. Some examples of such a mechanism can use spring-loaded pins or buttons (e.g., detent pins) that engage with holes in the outer tubes to lock the tubes at different heights. In some embodiments, a bar can extend between such a pair of collapsible poles, which can include a button, which when pressed, retracts pins that otherwise protrude through holes in the outer tube to keep the bar and pair of collapsible poles locked at one or more specific height (e.g., a maximum height, a fully collapsed height, one or more height between maximum and fully collapsed, and the like).

In some embodiments, configuring the containment chamber 100 from the expanded state to a first or second collapsed state can reduce the height of the containment chamber 100 by 4 inches, 8 inches, 12 inches, 16 inches, 20 inches, 24 inches, 28 inches, 32 inches, 36 inches, 40 inches, 44 inches, 48 inches, or the like, or a range between such example values. In various example, the containment chamber 100 is only configured to be changed between the expanded state to a first and/or second collapsed state and is inoperable to be further collapsed aside from being disassembled or otherwise made inoperable for use.

In various embodiments, it can be desirable for a containment chamber 100 to be configured to be collapsible into a smaller configuration without removing a patient from a chamber of the isolation room because such a capability can allow the isolation room to be transported in vehicles or through openings with limited space or clearance, such as of an ambulance, helicopter, airplane, or the like. This can be desirable for allowing the containment chamber 100 to be mobile and portable in a variety of ways while also allowing for the patient and caretakers to have a larger operating volume within the isolation room when the containment chamber 100 is not being transported. This in various examples can allow for the improved portability and mobility of the containment chamber 100 while a patient is inside, while also maximizing the comfort of the patient and maximizing space for caretakers interacting with the patient when the containment chamber 100 is not being transported with the patient inside.

Additionally, while some examples can have a support architecture 110 that comprises linear or curved poles made of metal tubes, shock-corded poles or sectional poles, or the like (e.g., made of metal, fiberglass, plastic, or the like), it should be clear that any suitable support architecture 110 can be used in various embodiments. For example, some embodiments can include a support architecture 110 defined by spray foam, an air-blown support structure, or the like. Additionally, terms like “pole,” “beam,” and the like, should not be construed to be limiting on a specific type of structure or a specific shape (e.g., not limited to solid or hollow cylinders, solid or hollow rectangular tubes, and the like).

Various embodiments discussed herein related to a method of using a containment chamber 100 that can include assembling the containment chamber 100 from a packed state to an expanded state. For example, in various embodiments, the walls 130 of the containment chamber can be folded in a flat configuration and the architecture 110 can be partially or full disassembled, which can be desirable for storage and transport.

As discussed herein, various embodiments include an architecture that includes a plurality of vertical poles 111, a plurality of top-of-wall beams 112, one or more flexible roof support poles 113, and a base assembly 114 that can comprise a plurality of base poles. In some examples, assembling the architecture 110 at least includes coupling the one or more flexible roof support poles 113 to one or more of the plurality of vertical poles 111 and/or the plurality of top-of-wall beams; and attaching the walls 130 (e.g., a flexible polymer enclosure) to the architecture 110. The walls 130 (e.g., a flexible polymer enclosure) defining a chamber 150 via a plurality of walls 130 that include a plurality of end walls 132, a plurality of sidewalls 134, one or more roof walls 136, a plurality of couplings 115 attached to the one or more roof walls 136, and a floor wall 138. In various examples, attaching the walls 130 (e.g., a flexible polymer enclosure) to the architecture 110 includes coupling the plurality of couplings 115 to one or more flexible roof support poles 113 to suspend the plurality of walls 130 and configure the one or more roof walls 136 in an expanded state.

A method of use can also include disposing the containment chamber 100 on a mobile unit 199, which in some examples can include a foldable roll-in stretcher, a gurney, or the like. The base assembly 114 and the floor wall 138 can be disposed on the mobile unit 199. The method can also include opening the containment chamber 100 via one or more peripheral couplings 180 disposed in at least the plurality of sidewalls 134 and at least one of the plurality of end walls 132. Opening the containment chamber via one or more peripheral couplings 180 can result in generating access to an internal cavity 150 of the containment chamber 100 defined by the walls 130.

The method can also include positioning a patient within the open containment chamber 100 and specifically inside the internal cavity 150 of the containment chamber 100, with the patient disposed on or over the at least one of a foldable roll-in stretcher or the gurney, on or over the base assembly 114, and on or over the floor wall 138. Various embodiments can include sealing the containment chamber 100 via the one or more peripheral couplings 180 disposed in at least the plurality of sidewalls 134 and at least one of the plurality of end walls 132. Such sealing can result in isolating the patient within the internal cavity 150 of the containment chamber 100 defined by the walls 130.

A method of use can further include generating a negative pressure within a range of −2.5 to −2.7 Pa within the internal cavity 150 of the containment chamber 100 via an air filtration system 195 and moving the isolated patient from a first location to a second location via one or more users pushing the at least one of a foldable roll-in stretcher or gurney that the containment chamber 100 is disposed on.

A method of using a containment chamber 100 can further include configuring one or more roof walls 136 from an expanded state to a collapsed state by de-coupling a plurality of couplings 115 from the one or more flexible roof support poles 113, and detaching the one or more flexible roof support poles 113 from the architecture 110. Configuring the one or more roof walls 136 from the expanded state to the collapsed state can causes the volume of the internal cavity of the chamber 150 defined by a flexible polymer enclosure to decrease (e.g., by between 2 and 10 cubic feet) and can cause the height of the containment chamber 100 to be reduced (e.g., by between 4 and 24 inches). In various embodiments, the containment chamber 100 remains operable in both the expanded state in the collapsed state to isolate the patient and to generate the negative pressure (e.g., within a range of −2.5 to −2.7 Pa) within the internal cavity 150 of the containment chamber 100 via the air filtration system 195.

Various embodiments can include moving the patient from the second location to a third location via one or more users pushing a foldable roll-in stretcher, gurney, or the like, where moving the patient from the second location to the third location includes moving the patient through a door or opening that the containment chamber 100 on a mobile unit 199 (e.g., a foldable roll-in stretcher, gurney, or the like, would be inoperable to fit through in the expanded state, but is operable to fit through in the collapsed state. In various embodiments, when the containment chamber 100 is in the collapsed state, the containment chamber remains operable to isolate the patient and generate the negative pressure within a range of −2.5 to −2.7 Pa.

In various embodiments, a containment chamber 100 can be configured for use as a portable Patient Isolation Unit (PIU) designed to prevent particulate (e.g., biological) cross-contamination between an enclosed contaminated patient and the external environment during care and with one or more features that enables select medical interventions to the patient via end-user supplied medical equipment.

In various embodiments the containment chamber 100 can be configured to have a use life of at least 48 hours of continuous use. For example, the materials forming the plurality of walls 130 can be selected to maintain structural integrity, flexibility, optical clarity, and contamination resistance over extended periods of negative-pressure operation. In some embodiments, the flexible polymer films that define the walls 130 (e.g., PVC, TPU, HDPE, vinyl, or the like) can be formulated with plasticizers, UV stabilizers, anti-fog coatings, or abrasion-resistant surface treatments that allow the material to withstand multiple days of mechanical stress from airflow, negative pressure loading, and incidental contact with medical equipment or caregivers interacting with interfaces 170. The seams of the walls 130 can be welded, heat-fused, adhered, or mechanically bonded in ways that ensure seam integrity remains intact for at least 48 hours, even under cyclic pressurization and temperature or humidity fluctuations.

In further embodiments, the air filtration system 195 can be configured to maintain stable performance for at least 48 continuous hours, including maintaining a negative pressure of at least −2.5 Pascals throughout a range of external environmental conditions. For example, the fan, filter elements, and electrical components can be selected and tested to support continuous high-duty operation (e.g., 5-30 ACH) without overheating or reduction in filtration efficiency. Some embodiments may include a thermal cutoff or passive cooling system to prevent degradation of the fan or filter media during prolonged use. The air filtration system 195 can also include intake and exhaust ports configured to resist occlusion, fouling, or particle loading that could otherwise reduce airflow over time. In some embodiments, the filtration system 195 can include a pressure monitoring sensor or visual indicator that alerts a user if performance begins to deviate from acceptable operating ranges during extended operation.

In some embodiments, the structural components of the architecture 110 (e.g., vertical poles 111, top-of-wall beams 112, roof support poles 113, and the base assembly 114, and the like) can be configured to withstand at least 48 hours of continuous tension, compression, and dynamic loading without bending, collapsing, or loosening. Mechanical connectors such as sockets, brackets, clamps, telescoping segments, and push-button locking structures can be designed to resist creep or fatigue over extended periods. In various embodiments, couplings 115 used to secure the walls 130 to the architecture 110 can be configured to maintain their attachment force or sealing capability for the full 48-hour use period, even when exposed to mechanical vibrations, patient movement inside the chamber 150, or repeated manipulation of interfaces 170 such as glove interfaces 170A or pass-throughs 175.

In some embodiments, the containment chamber 100 can also be configured to maintain sanitary conditions and biosecurity for at least 48 continuous hours. For example, the internal surfaces of the walls 130 and floor wall 138 can be designed to resist accumulation of condensation, moisture, or biological debris during extended operation. Surface treatments or coatings may be utilized to reduce fogging, microbial adhesion, or static buildup. Additionally, the flexible walls 130 can be chemically compatible with disinfectants used during extended-use cycles, such as quaternary ammonium compounds, hydrogen peroxide wipes, or bleach solutions of less than 10%, such that routine surface cleaning over a 48-hour period does not degrade or embrittle the material.

In some examples, the containment chamber 100 can include features such as reinforced attachment points, replaceable glove interfaces 170A, and modular couplings 115 configured to withstand repeated user interactions over the 48-hour period. For example, glove interfaces 170A may include reinforced cuffs or cinch assemblies that maintain integrity after dozens of manipulations by caretakers. Pass-through units 1550 can be designed to maintain seals around tubing or lines for the duration of the 48-hour use life. Collectively, these design considerations can allow the containment chamber 100 to reliably maintain negative pressure, structural stability, and bio-secure environmental isolation during at least 48 hours of continuous clinical use.

In various embodiments the containment chamber 100 can be configured to have replaceable component points of attachment that withstand at least 10 changes without loss of integrity. For example, interface elements such as glove interfaces 170A, elongated interface units 170B, pass-through units 1550, couplings 115, peripheral couplings 180, and modular interface frames can be designed so that they may be removed, replaced, or repositioned multiple times without degrading the sealing surfaces or weakening the surrounding wall material 130. In some embodiments, the polymer films forming the walls 130 may include reinforced attachment regions (e.g., multilayer patches, heat-sealed backing plates, welded reinforcement rings, or the like) configured to distribute forces applied during installation or removal of components, thereby preventing tearing, stretching, or fatigue after repeated cycles of replacement.

In further embodiments, the attachment mechanisms themselves can be configured to tolerate repeated mechanical engagement and disengagement. For example, couplings 115 may include grommets, snap fasteners, magnetic interfaces, adhesive pads, hook-and-loop fasteners, or molded attachment points that are rated for at least 10 install/remove cycles. A glove interface 170A secured by a modular interface frame may utilize a combination of mechanical fasteners (e.g., screws, clips, or slide-lock rails) and sealed polymer flanges to allow for repeated replacement while maintaining airtight integrity. In some embodiments, interface frames can include compressive gaskets, elastomeric seals, or captured O-rings that return to their original shape after repeated clamping events, ensuring that each subsequent installation maintains the same level of bio-secure sealing as the first.

In some embodiments, the containment chamber 100 can include replaceable components associated with airflow, filtration, or monitoring systems (e.g., filter housings, sensor mounts, intake and exhaust connection points, and the like) that are configured for repeated replacement without compromising the operational integrity of the chamber 150. For example, an intake filter welded directly to a wall 130 may be mounted to a surrounding reinforced frame configured to accept new filter assemblies via mechanical locking tabs or adhesive-backed sealing strips that can be repeatedly engaged. Likewise, a pass-through unit 1550 can be removed and replaced multiple times by disengaging a pass-through frame 1570 while the reinforced region of the wall 130 maintains its structural and sealing properties.

In some embodiments, replaceable attachment points can be validated through testing that simulates repeated clinical use cycles, including attaching and removing components under negative-pressure conditions, cleaning with harsh disinfectants, and manipulating the components during medical procedures. Such testing can ensure that seals do not degrade, polymer sheets do not develop micro-tears, and attachment frames do not loosen. Collectively, these embodiments can allow the containment chamber 100 to accommodate modular replacement of high-use components at least 10 times (e.g., replacing gloves after contamination, swapping pass-through configurations, or installing alternative interface modules) without loss of structural integrity or bio-secure sealing performance.

In various embodiments the containment chamber 100 can be configured to allow for two-person patient transfer into the chamber 150 of the containment chamber 100. For example, the geometry of the base assembly 114, the width of the bottom portion 182 of the walls 130, and the configuration of the peripheral coupling 180 can be designed to provide sufficient clearance for two caregivers to safely maneuver and position a patient onto a bed 190 or support surface within the chamber 150. In some embodiments, the peripheral coupling 180 may be positioned along a slanted or horizontal seam that opens the top portion 184 widely enough to permit two caregivers to simultaneously access the patient-loading region without obstruction from the flexible walls 130 or the architecture 110. The bottom portion 182 can be designed to remain structurally stable during such loading, preventing collapse or inward deflection of the chamber walls during transfer.

In some embodiments, the base assembly 114 can be configured with a low-profile loading height, rigid support deck, or lateral reinforcement rails that allow two caregivers to lift, slide, or pivot a patient into the chamber 150 using standard patient-transfer equipment such as backboards, transfer sheets, or sliding boards. The frame geometry may include open side regions or recessed rail segments configured to receive the hands, knees, or body weight of caregivers performing a two-person lift or lateral transfer. In various examples, the base assembly 114 can be sized such that its width and length accommodate two-person lifting ergonomics while still maintaining compatibility with standard stretchers, gurneys, and roll-in medical transport systems.

In additional embodiments, the containment chamber 100 can be configured such that structural components like vertical poles 111, top-of-wall beams 112, or roof support poles 113 do not obstruct or interfere with two-person patient transfer. For example, the removable roof support poles 113 may be designed to be detached or collapsed upward prior to patient loading to create a larger opening at the top of the chamber 150. Similarly, couplings 115 securing the flexible walls 130 to the architecture 110 may be selectively disengaged in certain regions to temporarily widen the entry aperture for a two-person transfer without requiring full disassembly of the chamber. Once the patient is positioned within the chamber 150, these components can be rapidly re-secured to restore structural stability and airtight isolation.

In some embodiments, the interior surfaces of the chamber 150 may include low-friction coatings, reinforced floor wall 138 materials, or integrated pull-handles that assist caregivers during sliding or pivot-based transfers. The configuration may also accommodate incline adjustments (e.g., raising one end of a bed 190) allowing a two-person team to maneuver the patient more safely. Collectively, these features can allow the containment chamber 100 to facilitate ergonomic, safe, and efficient two-person patient transfer while maintaining compatibility with negative-pressure operation, modular interfaces, and the overall bio-secure design of the system.

In various embodiments, the containment chamber 100 can be configured for emergency breach access to the patient head, airway, and/or groin area with the ability to reseal the chamber 150 of the containment chamber 100. For example, one or more walls 130 (e.g., one or more an end-wall 132, sidewall 134, or roof wall 136) can include an emergency access panel configured to be rapidly opened by a caregiver to reach critical anatomical regions requiring immediate intervention, such as for airway management, hemorrhage control, intubation, or emergency vascular access. In some embodiments, such access panels can be defined by a tear-away seam, perforated region, or frangible closure that can be breached in seconds using hand force or a simple tool, while still maintaining a predictable and controlled opening path to minimize uncontrolled tearing of the flexible polymer material.

In further embodiments, the emergency breach area can incorporate a resealable closure system that allows the chamber 150 to be re-isolated after the emergency intervention is completed. For example, the breached region may include a sealing mechanism such as a zipper, double-sided adhesive strip, hook-and-loop fastener, magnetic seal track, clamp-style rail, or a combination of such features, positioned adjacent to the frangible, openable or tear-away seam. Upon breaching the emergency access panel, the caregiver can peel back the panel to gain access to the patient's head, airway, and/or groin and, once the necessary procedure is complete, re-close the chamber by activating a seal. In some embodiments, the resealing mechanism can overlap or interlock with portions of the wall 130 to maintain negative pressure within the chamber 150 following resealing.

In some embodiments, dedicated emergency access zones can be reinforced with layered polymer films, welded perimeter rings, or integrated tabs that allow the panel to be quickly grasped and breached in a controlled manner. These reinforced regions may be located directly above the patient's head region, along the upper sidewall 134, or adjacent to the floor wall 138 near the groin area. Additionally, the geometry of the architecture 110 may be configured such that the top-of-wall beams 112 or roof support poles 113 do not obstruct emergency access paths or may be collapsible or removable to rapidly increase the available access aperture during an emergent procedure.

In some embodiments, visual indicators such as printed icons, contrasting color strips, or tactile markers may be incorporated into the emergency breach panels to signal the proper location and direction of pull to caregivers, particularly in low-light or high-stress situations. Resealable regions may also be marked accordingly to ensure proper closure following an emergency intervention. Testing protocols may be used to validate that the emergency breach and reseal cycle can be performed while maintaining the required negative pressure range (e.g., −2.5 to −2.7 Pa.) after resealing.

Collectively, some such embodiments can provide the containment chamber 100 with the ability to permit rapid caregiver access to critical anatomical regions during emergencies while still preserving the bio-secure integrity of the chamber 150 once the emergency procedure is completed.

In various embodiments the containment chamber 100 can be configured for passing through (e.g., via a pass-through 175) one or more types of equipment discussed herein, or the like. For example, the sidewalls 134, end-walls 132, or other suitable portions of the walls 130 can include one or more pass-throughs 175 configured to permit medical equipment, monitoring devices, therapeutic tubing, respiratory circuits, power lines, communication lines, and other clinical apparatus to extend between the external environment and the chamber 150 while maintaining a sealed and contamination-resistant barrier. As discussed herein, such pass-throughs 175 can include one or more pass-through units 1550, which in some embodiments can be configured with removable tips, resealable openings, or compressive couplers 1624 to create a substantially airtight seal around inserted equipment.

In some embodiments, the pass-throughs 175 can be sized, shaped, or arranged to accommodate a variety of equipment having different diameters and geometries. For example, larger pass-through units 1550 may be configured to permit passage of ventilator tubing, suction tubing, or transfusion lines, while smaller pass-through units 1550 may be configured to receive peripheral IV lines, sensor leads, or catheter lines. The flexible polymer sheets 1621 defining each pass-through slot 1626 can deform around inserted equipment while remaining captured by a compressive coupling 1624, which can include an adhesive strip, mechanical clamp, hook-and-loop fastening interface, zipper, magnetic strip, or the like. In various examples, these sealing components can be configured to maintain structural and sealing integrity for extended periods of negative-pressure operation.

In some embodiments, the pass-throughs 175 can be modular or replaceable, allowing a user to configure the containment chamber 100 for specific clinical scenarios. For instance, a pass-through frame 1570 can be permanently welded or bonded to a wall 130, with the frame configured to accept interchangeable pass-through units 1550 such as units designed for respiratory therapy, vascular access, electrical equipment, or monitoring devices. In some embodiments, the pass-through frame 1570 can also hold a flat sealing panel when no equipment needs to pass through that region, thereby maintaining the required negative pressure and bio-secure barrier.

In some embodiments, pass-throughs 175 can include extended flanges or flexible pockets configured to direct any leakage path back into the chamber 150 under negative pressure conditions. For example, a pass-through unit 1550 may extend outward from the wall 130 to allow manipulation of couplers 1624 externally while preventing the exterior environment from contacting the interior sealing surfaces. In addition, the coupler 1624 may include dual opposing sealing faces that can be clamped around an inserted tube 1628 to maintain isolation even under heavy bending, tension, or vibration of the equipment.

In various embodiments, the arrangement of the pass-throughs 175 can be selected to reduce interference with other components of the containment chamber 100, such as glove interfaces 170, the base assembly 114, or internal equipment positioned on a bed 190. The pass-throughs 175 may be positioned at heights and orientations ergonomically suited for clinicians performing vascular access, respiratory management, phlebotomy, infusion therapy, or continuous monitoring. This configuration can allow equipment to be introduced, removed, replaced, or repositioned without requiring the containment chamber 100 to be opened, thereby preserving the negative-pressure environment and maintaining patient isolation.

In various embodiments the containment chamber 100 can be configured to contain one or more pockets on the interior of the chamber 150 large enough to hold a 1200 mL suction canister. For example, one or more walls 130 (e.g., a sidewall 134, end-wall 132, or floor-adjacent region) can include an internal pocket 198 formed from a flexible polymer sheet, mesh panel, reinforced fabric, or welded film segment configured to securely retain a suction canister or similar medical device during use. In some embodiments, the pocket 198 can be permanently affixed to the interior surface of a wall 130 via heat welding, adhesion, stitching, or mechanical fasteners, creating a durable compartment capable of supporting the weight and profile of a fully filled 1200 mL canister without tearing or detaching from the wall 130.

In further embodiments, the internal pockets 198 can be shaped and dimensioned to accommodate not only the canister itself, but associated tubing, connectors, and drainage lines used during suction operations. For example, the pocket 198 may include an elongated upper opening, reinforced rim, or elasticized retention band configured to prevent the canister from tipping or shifting during transport, patient movement, or changes in chamber orientation. The height and depth of the pocket 198 can be selected to position the suction canister in an upright orientation within the chamber 150, allowing gravity-assisted drainage while ensuring that the canister remains easily visible to caregivers through the transparent or translucent portions of the walls 130.

In some embodiments, the pockets 198 may be modular or replaceable. For example, a pocket 198 may attach to an internal mounting patch or interface frame through hook-and-loop fasteners, snaps, zippers, or other removable couplings 115, allowing the pocket to be replaced, relocated, or cleaned between uses. Such modular pockets can be desirable when different clinical scenarios require different sizes or configurations of storage compartments, or when multiple pockets are used simultaneously to store additional medical supplies such as gloves, dressing materials, small monitors, drainage bags, or medication delivery components.

In additional embodiments, pockets 198 may be designed to maintain the negative-pressure environment of the chamber 150 by preventing tubing or drainage lines extending from the suction canister from disrupting the airtight seal of the walls 130. In some examples, a pocket 198 may be positioned adjacent to a pass-through 175, enabling the suction tubing to extend through the pass-through 175 while the canister remains secured within the internal pocket. In such embodiments, the pass-through 175 can be configured to seal around the tubing as described herein, ensuring that the introduction of suction equipment does not compromise the bio-secure containment of the chamber.

Collectively, some such embodiments can allow the containment chamber 100 to securely house a 1200 mL suction canister or similar medical device within the chamber 150 while maintaining visibility, accessibility, and the structural and sealing integrity required for extended negative-pressure operation.

In various embodiments the containment chamber 100 can be configured to allow for patient head inclination of 0-40 degrees. For example, the base assembly 114 can be configured to support a bed 190, stretcher surface, or adjustable patient platform capable of elevating the head region relative to the remainder of the body while the patient is positioned within the chamber 150. In some embodiments, the architecture 110 (e.g., including the vertical poles 111, top-of-wall beams 112, roof support poles 113, and the like) can define sufficient vertical clearance above the head region to accommodate elevation without interference from the flexible roof wall 136 or structural components of the chamber. The walls 130 can be configured with excess height, compliant geometry, or expandable polymer film segments that allow the roof wall 136 to rise or deform without creating undue tension when the patient's head is inclined.

In various embodiments the containment chamber 100 can be configured to allow for patient head inclination of 0-10, 0-20, 0-30, 0-40, 0-50, 0-60, 0-70, 0-80, 0-90 degrees, or the like, or a range between such example values in a full expanded configuration. For example, when the architecture 110 is in its expanded configuration (e.g., with the roof support poles 113 tensioned upward and the top-of-wall beams 112 fully extended) the chamber 150 can provide an enlarged headspace at one end of the chamber to support near-upright positioning. This can be desirable in various clinical scenarios, such as assisting patient breathing, reducing aspiration risk, improving airway access, or accommodating medical procedures performed through glove interfaces 170. In such embodiments, the slope created by differing heights of the vertical poles 111 can further enhance available headroom, enabling the patient's torso and head to be raised to higher angles while maintaining proper sealing and negative-pressure containment.

In further embodiments the containment chamber 100 can be configured to allow for patient head inclination of 0-10, 0-20, 0-30, 0-40, 0-50, 0-60 degrees, or the like, or a range between such example values in a full collapsed configuration. For example, when one or more roof support poles 113 are removed or collapsed and the architecture 110 is transitioned to a lower-profile state (e.g., for transport in an ambulance, aircraft, or constricted space), the flexible roof wall 136 can drape or fold downward while still maintaining sufficient clearance to support moderate head elevation. In some embodiments, the roof wall 136 may include pleats, gussets, or compliant sections enabling localized expansion over the head region even when the overall chamber profile is reduced. Additionally, the base assembly 114 may include a recessed well or angled support surface near the head end that allows the patient's upper body to be inclined without substantially increasing the overall height of the containment chamber 100.

In some embodiments, the containment chamber 100 may further include securing straps, angled bedding supports, or adjustable wedges integrated into or placed upon the bed 190 to facilitate consistent and safe head elevation across the range of supported angles. The interface locations (e.g., glove interfaces 170A near the head region) may be positioned to remain ergonomically accessible to caregivers regardless of the selected inclination angle. Collectively, these features in some examples can allow the containment chamber 100 to safely support a wide range of patient head-inclination positions in both the fully expanded and fully collapsed configurations, while maintaining negative pressure, structural integrity, and bio-secure containment.

In various embodiments the containment chamber 100 can be configured to have an element for visually indicating the pressure status (e.g., within range or out of range) of the chamber 150 of the containment chamber 100. For example, the containment chamber 100 can include a pressure indicator element disposed on an interior or exterior portion of one or more walls 130, or on an associated component such as the air filtration system 195 or an integrated sensor module. Such a pressure indicator element can comprise, for instance, an electronic display, LED status light, mechanical gauge, color-changing indicator patch, or a dual-state visual flag that changes orientation under negative pressure. In some embodiments, the indicator can be directly coupled to a pressure sensing device configured to continuously monitor the internal pressure of the chamber 150 and provide a visual cue when the pressure is within a desired operational range (e.g., less than or equal to −2.5 Pa.) or when the pressure deviates outside acceptable thresholds.

In further embodiments, the pressure indicator can be configured to remain highly visible through the transparent or translucent portions of the top portion 184 or roof wall 136 so that caregivers can easily verify pressure status during patient care. For example, an LED indicator could emit a green light when the negative pressure is maintained within the desired range and a red or amber light when the pressure rises above or falls below target values. In some embodiments, a mechanical negative-pressure flag or diaphragm-based indicator can flex inward when the chamber 150 is properly evacuated, providing a simple visual cue without the need for electronic components. Additionally, the indicator element may include reflective or high-contrast features to enhance visibility in low-light conditions or dense clinical environments.

In various embodiments the containment chamber 100 can be configured for a practitioner to have the ability to see a pressure sensor status when sitting at the head of the patient. For example, the location of the pressure indicator element can be selected so that it is visible from a seated or kneeling position near the head end of the chamber 150, where critical care activities such as airway management, intubation, or respiratory assessment often occur. In some embodiments, the pressure indicator can be positioned on the upper portion of a sidewall 134 or end-wall 132 adjacent the head region, or mounted to a bracket, frame segment, or raised support element extending above the top-of-wall beams 112. This configuration of some examples can allow practitioners performing head-level procedures to maintain continuous awareness of pressure status without repositioning or interrupting their clinical workflow.

In some embodiments, the geometry of the architecture 110 can be configured to ensure that structural elements such as vertical poles 111, roof support poles 113, or couplings 115 do not obstruct the practitioner's line of sight to the pressure indicator element. For example, the indicator may be positioned within a clear window section of the top portion 184, or on a dedicated internal panel angled toward the practitioner's position at the head of the patient. In further embodiments, the pressure indicator may include an enlarged viewing surface, directional illumination, or an adjustable mounting bracket to ensure visibility regardless of patient head inclination, roof-wall configuration (e.g., collapsed vs. expanded), or caregiver posture.

Collectively, some such embodiments can allow the containment chamber 100 to provide real-time, easily visible negative-pressure status information to clinicians positioned at the head of the patient, thereby supporting safe operation, rapid emergency response, and precise maintenance of the required isolation environment.

In various embodiments the containment chamber 100 can be configured to withstand at least 30 practitioner interactions without loss of integrity or function. For example, the flexible polymer walls 130, reinforcement regions, and attachment points can be designed to tolerate repeated manipulation by clinicians performing tasks such as adjusting glove interfaces 170A, accessing pass-throughs 175, repositioning the patient on bed 190, interfacing with monitoring equipment, or manipulating the peripheral coupling 180 during setup or emergency procedures. In some embodiments, the polymer films (e.g., PVC, TPU, HDPE, vinyl, or the like) can include strengthened seams, multi-layer laminates, or welded reinforcement bands positioned along high-stress regions to prevent tearing, stretching, or thinning after repeated interactions over the course of extended clinical use.

In further embodiments, the couplings 115 that secure the walls 130 to the architecture 110 can be configured to maintain consistent attachment strength after at least 30 cycles of manipulation, tensioning, or repositioning. For example, couplings 115 (e.g., bungee ties, clips, snaps, magnets, hook-and-loop fasteners, or the like) may be selected based on their ability to repeatedly engage and disengage without degradation of mechanical performance or sealing capability. Similarly, glove interfaces 170A can be formed of durable elastomeric materials with reinforced cuffs, welded seams, and cinch assemblies configured to maintain airtight integrity and tactile usability even after dozens of caregiver interactions. In some embodiments, the gloves can be replaceable via modular interface frames configured to withstand repeated glove removal and replacement cycles.

In additional embodiments, repeated practitioner interactions may involve manipulation of pass-through units 1550 or the insertion and removal of various clinical tools, tubing, or cables. Accordingly, pass-through frames 1570, sealing couplers 1624, and flexible sheets 1621 can be designed to resist fatigue, delamination, or loss of sealing ability after numerous engagements. Optional reinforcing patches may be welded or adhered around each pass-through 175 to ensure that pressure differentials, bending loads, and twisting forces applied during repeated use do not compromise the negative-pressure environment of the chamber 150. In further embodiments, mechanical elements of the architecture 110 (e.g., vertical poles 111, top-of-wall beams 112, roof support poles 113, and associated sockets or brackets) can be rated for repeated adjustments or collapsible cycles without developing looseness or instability.

In some embodiments, durability testing can simulate at least 30 typical practitioner interactions to validate that the containment chamber 100 maintains functionality and bio-secure sealing throughout the intended use period. Such testing may include repeated cycles of glove interface manipulation, pass-through use, patient repositioning, frame adjustment, and cleaning procedures using standard hospital disinfectants. These evaluations can ensure that material integrity, seam strength, coupling performance, and negative-pressure retention remain substantially unchanged after repeated clinical interactions. Collectively, these features can allow the containment chamber 100 to sustain at least 30 practitioner interactions (e.g., those encountered during multi-hour stabilization, transport, or critical care) without loss of structural integrity, sealing performance, or operational functionality.

In various embodiments the containment chamber 100 can be configured to fit inside an Airbus H135 helicopter, a standard ambulance, air-ambulance fixed-wing airplanes, and the like (e.g., in a fully or partially collapsed configuration, but in some examples unable to fit in a fully expanded configuration). For example, the architecture 110 (e.g., vertical poles 111, top-of-wall beams 112, and roof support poles 113) can be configured to transition between an expanded configuration having a first overall height and width, and a collapsed configuration having a second overall height and width that fall within predetermined dimensional limits corresponding to the cargo or patient-transport compartments of such medical transport vehicles. In some embodiments, the collapsed configuration can have a height less than or equal to approximately 30 inches and a width less than or equal to approximately 24-30 inches, thereby enabling the containment chamber 100 to fit within the stretcher bay or loading doorway of an Airbus H135 helicopter or standard ground ambulance.

For example, standard ground ambulances in some embodiments can provide a patient-compartment loading-door height of approximately 68-72 inches, with some models offering internal vertical clearances of at least 72 inches or greater to accommodate stretcher loading and attendant access. In further embodiments, an Airbus H135 helicopter, when configured for emergency medical services, can provide a rear or side loading access height that is equal to or greater than those of standard ambulances, with practical loading clearances in many configurations falling within the range of approximately 72-80 inches or greater to support stretcher insertion and patient handling. Accordingly, in some embodiments, the containment chamber 100 can be dimensioned—particularly in its collapsed or partially collapsed configuration—to have an overall height less than or equal to such loading-door heights (e.g., less than or equal to 68, 70, 72, 75, or 80 inches, or a range between such values) to ensure that the containment chamber 100 can be introduced into or removed from these transport vehicles without interference.

In further embodiments, the containment chamber 100 may be explicitly dimensioned or dimensionally adjustable to fit within transport enclosures having known industry-standard dimensions. For example, the collapsed configuration can be configured to pass through openings of at least 24 inches, 26 inches, 28 inches, 30 inches, or 32 inches in width, and to fit beneath overhead clearance limits of at least 30 inches, 32 inches, 36 inches, or the like.

In some embodiments, one or more poles of the architecture 110 (e.g., vertical poles 111, roof support poles 113, or top-of-wall beams 112) can be removable, collapsible, or telescoping to achieve the collapsed configuration. For example, the roof support poles 113 may be removed to reduce the overall vertical profile, and telescoping vertical poles 111 may be retracted to achieve a collapsed height suitable for loading into aircraft or ambulance compartments without requiring disassembly of the entire containment chamber 100. In certain embodiments, the flexible walls 130 and roof wall 136 may drape or fold naturally around the collapsed architecture 110 to produce a compact shape that remains sealed or sealable during transport.

In some embodiments, the base assembly 114 may be dimensioned to align with standard stretcher or litter dimensions used in air and ground medical transport systems. For example, the base assembly 114 may have a width less than or equal to 20, 22, 24, 26, 28, or 30 inches and a length suitable for being secured to a standard aeromedical stretcher frame. This configuration can allow the containment chamber 100 to be moved into and out of helicopters, ambulances, and fixed-wing aircraft using existing medical-transport infrastructure. Additionally, the containment chamber 100 may include integrated securing points or mounting interfaces configured to engage with the locking rails or retention brackets used in such vehicles.

Collectively, some such embodiments can allow the containment chamber 100 to be dimensionally compatible with rotor-wing (e.g., Airbus H135), ground-based, and fixed-wing air-ambulance transport environments in a collapsed or partially collapsed configuration, thereby enabling safe and continuous patient isolation during interfacility or emergency transport operations.

In various embodiments the containment chamber 100 can be configured to have an opening large enough to load a 6′8″ tall patient weighing 300 lbs. For example, the peripheral coupling 180, door 185, or other access structure can be dimensioned and arranged to create an opening having a minimum length, width, or diagonal clearance sufficient to permit the loading of a patient of such size along with any associated transfer equipment (e.g., backboards, sliding sheets, or stretcher platforms). In some embodiments, the opening created by the peripheral coupling 180 when fully or partially decoupled can have a length of at least 80 inches and a width of at least 22-30 inches, or a diagonal clearance of at least 84 inches, thereby allowing a 6′8″ (80-inch) tall patient to be inserted without bending, compressing, or distorting the chamber 150 in a way that would compromise structural or sealing integrity.

In additional embodiments, the opening can be configured to permit the passage of a patient whose combined body width and transfer apparatus width fall within predetermined limits (e.g., 20-32 inches), ensuring that standard bariatric or near-bariatric transfer equipment can be used while maintaining the isolation function of the containment chamber 100.

In further embodiments, the location and geometry of the access opening can be selected to facilitate safe, ergonomic loading of a large patient. For example, a slanted peripheral coupling 180 may allow the top portion 184 of the walls 130 to fold back or hinge away from the base assembly 114, creating a widened entry corridor along the longitudinal axis of the chamber 150. In some embodiments, the door 185 may be positioned on an end-wall 132 and configured with a hinge 186 and locking mechanism strong enough to support repeated transfers of large patients without deformation. Reinforced seams, welded structural patches, or rigid perimeter frames may surround the opening region to ensure that the containment chamber 100 remains stable under the weight and movement of a patient weighing 300 pounds during loading.

In some embodiments, the base assembly 114 may also be configured to support the mass and dimensions of a 6′8″, 300-lb patient during loading. For example, the perimeter frame, transverse support bars, and longitudinal rails may be rated for loads exceeding 300 lbs, ensuring that deflection, bending, or buckling does not occur as the patient is moved into the chamber 150. Where the containment chamber 100 is designed for use with mobile transport units such as stretchers, gurneys, or aircraft litters, the base assembly 114 can be dimensioned to align with standard patient-support surfaces so that a large patient can be laterally transferred into the chamber with minimal vertical lift.

Collectively, some such embodiments can allow the containment chamber 100 to reliably accommodate the loading and safe isolation of large patients (e.g., individuals up to at least 6′8″ tall and weighing at least 300 lbs) while maintaining structural integrity, sealing performance, and compatibility with clinical transport and care procedures.

In various embodiments the containment chamber 100 can be configured in one preferred embodiment to have a total weight of less than 45 lbs. For example, the materials selected for the architecture 110, the walls 130, the base assembly 114, and the air filtration system 195 can be chosen to minimize overall mass while maintaining the structural integrity, durability, and negative-pressure performance required for clinical use. In some embodiments, lightweight structural components (e.g., aluminum alloy poles, fiberglass composite roof support poles 113, high-strength polymer connectors, thin-wall tubular beams, or the like) can be used to reduce mass without compromising strength. Likewise, the flexible polymer films forming the walls 130 can be selected to provide adequate tear resistance, puncture strength, and optical clarity while remaining lightweight and easy to fold for storage or transport.

In some embodiments, the containment chamber 100 can be configured to have a total weight of less than or equal to 25 lbs, 30 lbs, 40 lbs, 45 lbs, 50 lbs, 55 lbs, 60 lbs, 70 lbs, 80 lbs, 100 lbs, or the like, or a range between such example values. These weight configurations can allow the containment chamber 100 to be easily carried, assembled, and deployed by one or two individuals in field environments, emergency settings, or remote locations where logistical resources are limited. For example, reducing weight can be particularly advantageous when the containment chamber 100 is intended for helicopter transport, air-ambulance use, disaster response, or rapid deployment in temporary facilities. In some embodiments, the entire system (e.g., including the containment chamber 100, support architecture 110, and associated air filtration system 195) can be packaged into a transport container or bag that remains lightweight enough for manual handling by medical personnel.

In some embodiments, the configuration of the containment chamber 100 can balance weight reduction with long-term structural durability. For example, the base assembly 114 may incorporate aluminum or composite support rails, lightweight decking, or reinforced polymer panels that provide sufficient load-bearing capacity for patients while contributing minimally to overall weight. Couplings 115, pass-through frames 1570, and interface components 170 may also be formed from lightweight polymers or composite materials chosen for strength-to-weight efficiency. In additional embodiments, weight reduction may be achieved through modular design choices, such as allowing optional components (e.g., additional glove interfaces 170A, expanded pass-through arrays, auxiliary support poles, and the like) to be removed when not required for a given clinical scenario.

In various embodiments the containment chamber 100 can be configured to be assembled in less than 10 minutes with two persons following the Instructions for Use (IFU) steps to assemble. For example, the architecture 110 (e.g., including the vertical poles 111, top-of-wall beams 112, roof support poles 113, and the like) can be designed with simplified coupling mechanisms such as push-button locking pins, snap-fit connectors, keyed joints, telescoping segments, or friction-fit ferrules that allow rapid engagement without requiring complex alignment or significant manual force. In some embodiments, the poles and beams can be color-coded, shape-coded, or otherwise marked to provide intuitive guidance during setup, enabling two users to follow the IFU and complete assembly in a short time even in field environments or urgent clinical scenarios. The flexible walls 130, including the end-walls 132, sidewalls 134, roof wall 136, and floor wall 138, can be pre-attached or semi-attached to certain portions of the architecture 110 so that the walls automatically assume the correct orientation when the frame is unfolded or expanded.

In further embodiments, the containment chamber 100 can be configured to require a maximum of one tool to complete assembly or setup. For example, the architecture 110 may be designed so that all primary joints, pole couplings, and structural connections are tool-less, while a single optional tool (e.g., a small hex wrench, screwdriver, tensioning tool, or the like) may be used only for securing the base assembly 114, tightening a specific bracket, or attaching the air filtration system 195. In some embodiments, the required tool can be integrated into the system itself, such as being stored in a dedicated pocket, attached via a tether, or included within the packaging. Eliminating the need for multiple tools can be desirable in emergency conditions, transport scenarios, or field deployments where personnel must work quickly and where available resources may be limited.

In some embodiments, the containment chamber 100 may include pre-assembled substructures configured for rapid deployment. For example, a top-of-wall frame assembly may unfold from a compact configuration into a rigid rectangular geometry with a single motion, or the roof support poles 113 may be shock-corded segments that automatically align when expanded. Likewise, the base assembly 114 may incorporate quick-release brackets or pre-fixed sockets that allow the vertical poles 111 to be inserted and secured in seconds. In some embodiments, the flexible walls 130 may be stored in a folded configuration that unfolds into the correct orientation without requiring additional adjustments, thereby reducing the number of assembly steps and the need for specialized skills.

Collectively, some such configurations can allow two users to assemble the containment chamber 100 rapidly and with minimal equipment, enabling efficient deployment in clinical, transport, emergency, or field environments where speed, simplicity, and reliability are critical.

In various embodiments the containment chamber 100 can be configured for the base, frame, and/or fan to withstand a minimum of 20 cleaning procedures (e.g., as described in the IFU), without degradation or loss of function. For example, the base assembly 114, the structural elements of the architecture 110, and the housing of the air filtration system 195 may be formed from materials selected for their mechanical durability and chemical resistance to repeated cleaning cycles. Such materials can include anodized aluminum, powder-coated steel, reinforced polymer composites, high-density polyethylene (HDPE), acrylonitrile butadiene styrene (ABS), glass-filled nylon, or similar structural materials known for maintaining integrity under repeated exposure to liquid chemical disinfectants and mechanical wiping. In some embodiments, the seams, connectors, couplings 115, and mounting interfaces may incorporate welded joints, sealed fasteners, or molded features designed to resist loosening, corrosion, or surface cracking over numerous cleaning cycles.

In various embodiments the containment chamber 100 can be configured for some or all components to be cleanable without degradation using standard hospital cleaners, including quaternary ammonium compounds (quats), sodium hypochlorite (bleach), hydrogen peroxide, phenolics, peracetic acid, alcohol-based disinfectants, chlorhexidine gluconate, iodophors, glutaraldehyde, accelerated hydrogen peroxide solutions, and the like. For example, the walls 130 (e.g., comprising flexible polymer films such as TPU, PVC, vinyl, or medical-grade polyethylene) may be formulated or surface-treated to resist discoloration, embrittlement, fogging, delamination, or tackiness when repeatedly exposed to these cleaning agents. In further embodiments, surface finishes or protective coatings may be applied to high-touch regions (e.g., around glove interfaces 170A, pass-throughs 175, or peripheral couplings 180) to maintain optical clarity and mechanical strength during extended use and repeated sterilization.

In some embodiments the containment chamber 100 can be configured for canopy materials to be compatible with a bleach solution of less than 10%. For example, the flexible roof wall 136 and sidewalls 134 may include polymer formulations that tolerate hypochlorite-based cleaning without undergoing premature degradation, fading, or stress cracking. In some examples, welded seams, reinforcement patches, and window regions may use bleach-resistant adhesives or heat-sealed molecular bonds configured to maintain sealing integrity when exposed to repeated bleach-based cleaning cycles. Compatibility with sub-10% bleach solutions can be desirable for environments where high-level disinfection is required between patient transfers or during extended operational periods.

In further embodiments the containment chamber 100 can be configured for cleaning of the device to be prescribed in accordance with FDA Guidance on Reprocessing Medical Devices. For example, the materials, geometry, and surface finishes of the containment chamber 100 can be selected to withstand repeated application of cleaning agents, mechanical wiping motions, and contact times recommended under current FDA reprocessing protocols. The IFU may specify cleaning steps, dwell times, compatible disinfectants, and inspection criteria consistent with FDA expectations for reusable medical devices, ensuring that the containment chamber 100 remains safe to use throughout its intended operational life. In some embodiments, the device may be tested under simulated reprocessing cycles (e.g., including multiple applications of quaternary ammonium cleaners, bleach solutions less than 10%, and hydrogen peroxide agents) to validate that no meaningful deterioration of sealing, optical, or structural properties occurs.

Some such embodiments can allow the containment chamber 100 to maintain structural integrity, sealing performance, optical clarity, and functional reliability after at least 25 cleaning procedures, while remaining compatible with the full range of hospital-grade disinfectants and reprocessing workflows necessary for repeated clinical use.

In various embodiments the containment chamber 100 can be configured with a filter that performs at an efficiency equal to or greater than 99.97% for a particle size of 0.3 microns when measured at the outlet of the exhaust fan. For example, the air filtration system 195 can include a HEPA-grade filter element integrated into a rigid or semi-rigid filter housing that is joined to one or more of the walls 130. The filter media may comprise micro-glass, melt-blown polypropylene, or other fine-fiber filtration substrates capable of capturing particles at or below the 0.3-micron range with high efficiency. In some embodiments, the filter housing may incorporate gaskets, compression seals, molded channels, or perimeter welds configured to prevent bypass flow around the filter media so that all air exiting the chamber 150 is compelled to pass through the high-efficiency filtration pathway. The exhaust fan may be positioned downstream of the filter, or the system may include fan housings arranged to maintain negative pressure across the filter media, thereby ensuring consistent capture of aerosols, droplets, and particulate contaminants associated with an isolated patient.

In some embodiments the containment chamber 100 can be configured for an air intake to prevent the internal volume of the canopy from having a greater concentration of PM2.5 particulate than the exterior environment. For example, one or more intake filters (e.g., such as MERV-rated prefilters, electrostatic particulate screens, or fine-mesh particulate barriers) may be disposed upstream of any air inflow points into the chamber 150. These intake elements can condition external air before it enters the containment chamber 100, removing PM 2.5 particulate or reducing internal particulate concentration to levels less than or equal to ambient conditions outside the canopy. In some embodiments, the intake elements may be welded, adhered, or mechanically fastened directly to the flexible walls 130, forming a sealed interface that ensures all incoming air is filtered. Such intake filters may have rated efficiencies for particulate matter at 2.5 microns or smaller, enabling the system to maintain a protective internal air environment even in locations with elevated outdoor particulate loads.

In further embodiments, the air filtration system 195 and intake configuration may work together to maintain a continuous negative-pressure airflow pattern that further prevents the accumulation of PM2.5 within the chamber. For example, the exhaust HEPA filter may draw a greater volume of air than the intake allows, creating a unidirectional flow path that naturally draws external air through the intake filtration media and prevents suspended particulate from lingering within the chamber 150. In some embodiments, sensors or monitoring devices may be positioned within the chamber to provide real-time assessment of particulate levels, pressure states, and airflow conditions, thereby ensuring that PM2.5 concentrations remain below external ambient levels throughout the use period.

In various embodiments the containment chamber 100 can be configured to have a storage shelf life of at least five years in a climate-controlled environment or two years in an ambient environment not to exceed 120° F. For example, the flexible polymer walls 130 (e.g., including materials such as TPU, PVC, HDPE, or vinyl) may be formulated to resist long-term degradation mechanisms such as plasticizer migration, UV-induced embrittlement, hydrolysis, and oxidative breakdown. In some embodiments, the polymer films may incorporate stabilizing additives such as UV absorbers, antioxidants, thermal stabilizers, or anti-yellowing agents that extend the material's integrity and optical clarity throughout prolonged storage. Welded seams, reinforced patches, and adhesive bonds may also be selected or designed to maintain mechanical and sealing performance after multi-year storage cycles.

In further embodiments, the structural components of the architecture 110 (e.g., vertical poles 111, top-of-wall beams 112, and roof support poles 113) may be constructed from corrosion-resistant metals (e.g., aluminum alloys, stainless steel and the like), fiberglass composites, or chemically stable polymers designed to withstand long-term storage without warping, cracking, corrosion, or loss of mechanical strength. Certain elements of the base assembly 114, including transverse support members and rail structures, can be coated, anodized, or otherwise treated to prevent surface oxidation or deterioration during prolonged storage in environments where humidity or temperature fluctuations may occur.

In some embodiments, the air filtration system 195 and associated housings may be configured for extended storage life by utilizing filtration media and structural components that maintain their efficacy and integrity over time. For example, the HEPA or MERV-rated filter media may be packaged with moisture-control packets, sealed in protective barrier films, or otherwise stored in a manner that prevents moisture absorption, particulate contamination, or microbial growth during long-term storage. Fan housings, electrical connectors, and seals can be constructed in some examples from materials designed to withstand prolonged temperature exposure up to 120° F. without deformation, cracking, or loss of electrical insulation.

In some embodiments, the containment chamber 100 may be stored in a compact folded configuration within a dedicated transport/storage container configured to shield components from environmental exposure. The container may be water-resistant, dust-resistant, and insulated to limit temperature swings, thereby preserving the polymer materials, structural members, and filtration components for the full rated shelf-life duration. Desiccant packs, humidity indicators, or protective liners may be included in the storage container to maintain ideal conditions for long-term preservation.

In various embodiments the containment chamber 100 can include a reusable transport and/or storage container or bag that is water resistant to IP55 standards. For example, the transport container may be configured as a soft-sided or semi-rigid bag formed from coated nylon, polyurethane-laminated fabric, PVC-coated polyester, thermoplastic elastomer (TPE) laminates, or other suitable materials capable of withstanding low-pressure water jets and particulate ingress in accordance with IP55 performance criteria. In some embodiments, the bag may include welded seams, heat-sealed joints, or overlapped and bonded fabric layers that prevent water intrusion during routine handling, transport in wet environments, or exposure to rain during field deployment.

In further embodiments, the water-resistant transport container may include closures designed to maintain IP55-level protection. For example, the container may incorporate water-resistant zippers, roll-top closures, flap-covered openings, compression-seal buckles, or hook-and-loop storm guards that inhibit liquid ingress while allowing rapid access to the folded containment chamber 100 and associated components. In some cases, zipper tracks may be coated with hydrophobic materials or shielded beneath welded storm flaps to further improve water resistance. Reinforcement panels or abrasion-resistant patches may be applied to high-wear regions of the container to ensure durability during repeated use, loading into emergency vehicles, or transport across rough terrain.

In various embodiments the containment chamber 100 can be configured to meet Environmental Conditioning performance requirements based on ASTM D4332. For example, materials forming the walls 130—including flexible polymer films such as TPU, PVC, HDPE, or vinyl—may be selected and tested to maintain structural integrity, flexibility, optical clarity, and seal performance after exposure to extreme temperature and humidity conditions prescribed under ASTM D4332. Such conditioning may include exposure to −30° C. (±2°C) at uncontrolled relative humidity (RH) for 72 hours, which can be desirable to ensure that the polymer materials resist cold-induced embrittlement, cracking, or delamination during transportation or storage in low-temperature environments. In some embodiments, the welded seams, adhesive bonds, and reinforcement regions of the walls 130 may be formulated to tolerate freezing-level temperatures without loss of tensile strength or airtightness.

In further embodiments, the containment chamber 100 can be configured to withstand exposure to elevated temperature and high-humidity conditions such as 40° C. (±2°C) at 90% RH (±5% RH) for 72 hours. For example, the architecture 110 (e.g., vertical poles 111, top-of-wall beams 112, and roof support poles 113) may be formed from corrosion-resistant metals or composite materials that maintain stiffness and shape under high-humidity environments. Likewise, couplings 115, interface frames 1123, and pass-through components 175 may incorporate hydrophobic coatings, molded polymers, or moisture-stable adhesives that resist swelling, softening, or dimensional distortion during prolonged exposure to humid conditions.

In some embodiments, the containment chamber 100 can be configured to withstand exposure to elevated temperature and low-humidity conditions, such as 60° C. (±2°C) at 15% RH (±5% RH) for 72 hours. For example, certain polymer films may be formulated with plasticizers or stabilizers to prevent drying-induced brittleness, surface crazing, or loss of transparency when subjected to hot, dry environments. The base assembly 114 and filtration system components (e.g., including the housing of the air filtration system 195) may incorporate heat-stable plastics or coated metals that resist thermal deformation, oxidation, or degradation of gaskets and seals.

In additional embodiments, the system may be designed so that all critical structural, functional, and sealing components retain acceptable performance metrics after undergoing the full sequence of environmental conditioning exposures. For example, after cycling through low-temperature, high-humidity, and high-temperature/low-humidity conditions, the containment chamber 100 may maintain its ability to generate and hold negative pressure, support patient weight on the base assembly 114, allow proper engagement of the peripheral coupling 180, and preserve optical clarity in observation regions of the walls 130. Testing according to ASTM D4332 conditioning profiles may be used to validate long-term material durability, storage survivability, and environmental resilience of the containment chamber 100 across diverse field, transport, and deployment scenarios.

In various embodiments the containment chamber 100 can be designed to support various clinical uses (e.g., Clinical Use Criteria), which in some embodiments can include one or more of the following: peripheral intravenous (PIV) placement, midline placement, code-esque central line placement, assistive breathing device placement and operation, parenteral line maintenance, complex vascular access maintenance, mechanically ventilated airway maintenance, phlebotomy with sample removal, Foley placement and maintenance, and wipe hygiene or waste manipulation to temporize patient needs during transport. For example, the walls 130 (e.g., glove interfaces 170A, elongated interface units 170B, and pass-throughs 175) may be positioned and dimensioned to provide clinicians with ergonomic access to the patient's arms, torso, neck, head, and groin regions while maintaining the sealed environment of the chamber 150. In some embodiments, the glove interfaces 170A may be arranged along the sidewalls 134 or end-walls 132 at strategic heights and angles tailored to the reach envelope required for PIV placement, midline catheter insertion, or central venous access under emergent conditions.

In further embodiments, the containment chamber 100 may be configured to enable assistive breathing device placement and operation, including non-invasive ventilation, airway management procedures, and, in some examples, intubation. For example, the architecture 110 may be designed to create sufficient internal volume and head-end clearance for clinicians to manipulate airway devices through the glove interfaces 170A. The top portion 184 of the chamber may be substantially transparent to allow direct visualization of the patient's face and airway. Pass-throughs 175 may be arranged to permit the insertion of ventilator tubes, oxygen lines, and monitoring cables while maintaining airtight seals. In some embodiments, elongated interface units 170B may be used to allow insertion and manipulation of advanced airway tools through flexible sleeves without breaching the chamber 150.

In some embodiments, the containment chamber 100 can be configured to support complex vascular access maintenance, such as miniaturized veno-venous ECMO (mini-vECMO), parenteral line management, or multi-lumen catheter access. The glove interfaces 170A on the sidewalls 134 may be located at positions that align with typical catheter access points on the torso or neck. Reinforced windows or transparent regions in the roof wall 136 may allow clinicians to visually confirm line placement or device positioning. Pass-throughs 175 may be sized to accommodate larger-diameter tubing needed for ECMO or similar devices while maintaining sealing integrity through couplers 1624, adhesive-bonded covers 1622, or redundant sealing mechanisms.

In additional embodiments, the containment chamber 100 may be configured to support procedures related to mechanically ventilated patients, including those already intubated and on respiratory support prior to entering the chamber 150. For example, the architecture 110 and flexible walls 130 may be designed to provide sufficient clearance above the patient's head for manipulation of ventilator circuits, suction catheters, or airway stabilization devices. Dedicated pass-throughs 175 may allow ventilator circuits to enter from the exterior environment while maintaining negative pressure within the chamber.

In further embodiments, the containment chamber 100 can support phlebotomy with sample removal, Foley catheter placement and maintenance, and hygiene procedures required to manage bodily fluids during transport. For example, lower-positioned glove interfaces 170A may be disposed near the pelvis or leg region to facilitate Foley catheter procedures. Waste removal, wiping hygiene, and other patient-care tasks may be performed using gloves or elongated interface sleeves while maintaining isolation. Optional internal pockets 198 may hold specimen containers, wipes, or temporary waste-management supplies accessible to the clinician from within the glove interfaces.

Collectively, some such embodiments can allow the containment chamber 100 to accommodate a wide range of essential clinical interventions while maintaining a sealed, negative-pressure environment. The arrangement of glove interfaces 170A, pass-throughs 175, transparent viewing regions, internal volume, and structural geometry of the architecture 110 can work together to enable clinicians to perform urgent, routine, and complex procedures without breaching containment or compromising patient or caregiver safety.

In various embodiments the containment chamber 100 can be configured for such clinical uses to be performed by various caretakers, physicians, or teams, such as a Critical Care Air Transport (CCAT) team, or the like. For example, the arrangement of glove interfaces 170A, elongated interface units 170B, pass-throughs 175, internal viewing windows, and the overall geometry of the chamber 150 can be designed to support workflows commonly used by emergency physicians, critical care specialists, flight medics, paramedics, respiratory therapists, and other advanced-level clinical personnel who may need to perform rapid or complex procedures while maintaining isolation. In some embodiments, ergonomic considerations (e.g., optimal interface height, reach distances, and the positioning of access features along the walls 130) may be incorporated so that trained teams can operate simultaneously from different sides of the containment chamber 100 without interfering with one another.

In further embodiments, the containment chamber 100 can be configured to support multi-person procedural access typical of CCAT teams or similar rapid-response medical groups. For example, multiple glove interfaces 170A may be disposed along opposing sidewalls 134 or end-walls 132, enabling two or more clinicians to work collaboratively on tasks such as central line placement, airway management, medication administration, or instrument handling. The internal volume and sloped roof wall 136 may be sized to permit overhead visualization and coordinated team movements, even in confined transport environments such as helicopters, fixed-wing aircraft, or ambulances where CCAT teams frequently operate.

In some embodiments, the containment chamber 100 may be configured with structural rigidity and mobility features that accommodate team-based patient handling. For instance, the base assembly 114 may be dimensioned for compatibility with standard stretcher or litter systems used by CCAT teams, allowing seamless transfer of a patient into or out of the chamber 150 during aeromedical evacuation missions. The architecture 110 may also be configured for rapid transition between expanded and collapsed states, enabling CCAT personnel to adjust the chamber height or roof profile during transport while maintaining negative pressure and isolation integrity.

In additional embodiments, the containment chamber 100 may be configured for use by diverse clinical teams beyond CCAT units, including emergency department teams, rapid response teams, transport medicine crews, infectious disease specialists, and military or humanitarian medical groups. For example, the layout of the containment chamber 100 may support both two-person and multi-person procedures, enabling flexible deployment across a variety of care environments. The design of the interface features may also account for the variety of personal protective equipment (PPE) worn by such teams, ensuring compatibility with gloved hands, thick protective garments, or helmeted personnel who may be performing procedures in challenging conditions.

Collectively, various embodiments can allow the containment chamber 100 to support coordinated, multi-provider medical interventions performed by specialized teams such as CCAT units, as well as by clinicians in hospitals, field medical stations, or transport environments. This configuration can enhance safety, usability, and procedural efficiency while ensuring that critical clinical activities can be conducted without breaching the isolation barrier.

In various embodiments, the containment chamber 100 can have various suitable internal chamber volumes including less than or equal to 10, 12, 14, 15, 16, 18, 20, 25, 30, 35, 40, 50 cubic feet, or the like, or a range between such example values. For example, the geometry defined by the architecture 110, including the height provided by the vertical poles 111, the width defined between opposing sidewalls 134, and the length defined between opposing end-walls 132, may be configured to achieve these internal volumes in a fully expanded configuration. In some embodiments, the chamber 150 may be optimized for a smaller volume (e.g., 10-20 cubic feet) suitable for aeromedical evacuation or transport medicine scenarios in which interior space is limited. In other embodiments, larger volumes (e.g., 30-50 cubic feet) may be desirable to allow enhanced clinician maneuverability, increased patient comfort, or the ability to operate additional medical equipment within the isolation system.

In various embodiments, an isolation room can be configured to be collapsible between a fully expanded and fully collapsed configuration (and one or more configurations therebetween), which can be configured to generate a change in volume of 0.5, 1, 2, 3, 4, 5, 6, 7, 8, 9, 10, 15, 20 cubic feet, or the like or a range between such example values. For example, the architecture 110 may incorporate telescoping vertical poles 111, removable or collapsible roof support poles 113, or foldable top-of-wall beams 112 that allow the overall height and internal volume of the chamber 150 to be reduced during transport. In some embodiments, removal or inward folding of the roof support poles 113 may reduce the vertical clearance of the chamber by several inches or more, yielding a corresponding controlled reduction in internal volume. In some embodiments, collapsing one or more vertical poles 111 may produce a larger change in volume (e.g., between 5 and 20 cubic feet) suitable for loading the containment chamber 100 into constrained transport environments such as ambulances, helicopters, or fixed-wing aircraft.

In some embodiments, intermediate configurations between the fully expanded and fully collapsed states may be used to tailor the internal chamber volume to specific operational needs. For example, a partially collapsed configuration may provide sufficient internal space for patient care while still meeting dimensional constraints of transport vehicles. This adjustability can be beneficial when transporting an isolated patient through a hospital corridor, doorway, elevator, or other limited-clearance environment. Volume-change mechanisms may include push-button detent systems, twist-lock telescoping mechanisms, snap-fit joints, or adjustable-length roof support poles 113 configured to shorten or lengthen the structural envelope of the containment chamber 100.

In some embodiments, the collapsible architecture may be designed so that the flexible walls 130, including the roof wall 136 and sidewalls 134, drape or fold in a predictable manner during transitions between volume states. Reinforcement bands, fabric channels, or alignment patches may guide the collapse of the walls such that the chamber 150 retains an orderly, sealed, and structurally sound geometry even when partially collapsed. Such configurations can allow the containment chamber 100 to maintain negative pressure, visual accessibility, and functional usability while its internal volume is adjusted in real time during patient transport or clinical operations.

Collectively, some such embodiments can allow the containment chamber 100 to assume a wide range of internal volumes (e.g., from compact transport configurations to spacious clinical configurations) and to transition smoothly between them while maintaining structural stability, environmental control, and isolation integrity.

In various embodiments, a method of using a containment chamber 100 can comprise assembling the containment chamber 100 including positioning the walls 130 that define the chamber 150 in a support architecture 110 and coupling one or more roof wall 136 to one or more roof support poles 113 via one or more couplers 115 so the containment chamber is in an expanded configuration. The method of use can further include configuring the containment chamber 100 to a collapsed state by de-coupling the couplers 115 from the roof support poles 113 and/or by removing the roof support poles 113, which can cause at least a portion of the roof wall(s) 136 to collapse and to reduce the volume of the chamber 150 defined by the walls 130.

In various embodiments a negative pressure can be generated in the isolation room system (or portions thereof) that is less than or equal to −1.2, −1.3, −1.4, −1.5, −1.6, −1.7, −1.8, −1.9, −2.0, −2.2, −2.5, −2.7, −3.0, −3.5, −4.0 Pascals, or the like or a range between such example values. For example, the air filtration system 195 may include one or more fans, blowers, or impeller units configured to draw air from the chamber 150 through a high-efficiency exhaust filter, thereby producing a controlled negative pressure relative to the external environment. In some embodiments, the system may regulate airflow using fixed or variable-speed fan motors, calibrated orifices, or passive flow restrictors that are selected to achieve consistent sub-ambient pressures across a range of operational conditions and chamber volumes. The architecture 110 and associated walls 130 may also be designed to maintain structural stability under these negative-pressure conditions, preventing inward collapse of the canopy while ensuring that any minor leaks result in air flowing into the chamber rather than out.

In further embodiments, the geometry and material properties of the flexible polymer walls 130 may be selected to accommodate the specified pressure ranges without excessive deformation or fluttering that could interfere with visibility or clinical procedures. Reinforced seams, welded joints, and integrated edge stiffeners may be used to ensure that negative pressure values (e.g., −2.5 to −3.0 Pascals) can be sustained continuously for extended periods. In some embodiments, the containment chamber 100 may include internal baffles, support ribs, or strategically located roof support poles 113 that prevent sagging or collapse of the roof wall 136 under elevated negative-pressure conditions.

In some embodiments, the intake pathways of the containment chamber 100 may be configured to ensure that incoming air is filtered, conditioned, or otherwise managed such that the negative pressure is maintained consistently. For instance, MERV-rated intake filters, passive intake valves, or controlled leakage paths may be used to supply make-up air to the chamber 150 at a rate proportional to the exhaust flow. The resulting pressure differential may fall within one of the enumerated values (e.g., less than or equal to −1.5 Pascals for minimal isolation or as low as −4.0 Pascals for high-isolation use cases) depending on clinical requirements, environmental conditions, and the patient's respiratory status.

In additional embodiments, sensors may be used to monitor the pressure within the containment chamber 100 and ensure that it remains within a predetermined negative-pressure range. Such sensors may include differential pressure transducers, visual manometers, color-changing indicators, or electronic readouts coupled to the air filtration system 195. The system may be configured to alert the user if the pressure deviates from the desired negative-pressure range, enabling prompt corrective action. In some embodiments, the system may include feedback control mechanisms that automatically adjust fan speed or intake flow pathways to maintain negative-pressure conditions at or below any of the enumerated values.

Some embodiments can include an interface 170 that is a lean-in glove panel interface that can comprise a lean-in body having a front panel, a pair of opposing sidewalls and a top panel, with a glove panel interface disposed within the front panel. A glove panel interface can be surrounded by an interface frame with a pair of gloves extending from a glove panel. The front panel can be rotatably coupled to the wall 130 via a hinge, which can allow the front panel to rotate toward and away from the wall 130 in which the lean-in glove panel interface is disposed.

Such an embodiment of a lean-in glove panel interface can be desirable by allowing a user (e.g., doctor, nurse, etc.) to be able to lean in and over a patient isolated in the containment chamber 100 by extending the lean-in glove panel interface into the chamber 150, which can improve the user's ability to view and interact with the isolated patient. Additionally, being able to retract the lean-in glove panel interface toward the wall can be desirable for maximizing space within the chamber 150 for the isolated patient, when the lean-in glove panel interface is not in use. A lean-in glove panel interface can be configured in various suitable ways, with various portions being flexible or rigid and having various suitable shapes and sizes.

In various embodiments, interfaces 170 or portions thereof can be modular. For example, an interface frame of a lean-in glove panel interface can be configured to modularly hold a glove panel interface, a door, another type of interface 170, a flat panel, or the like. Such a modular embodiment can be desirable by allowing a user to configure aspects of the containment chamber 100 based on desired capabilities, available modules, and the like. For example, where an interface 170 is not desired in a given location, a flat panel, or the like, can be coupled to a given interface frame, or various suitable interfaces 170 can be coupled to the interface frame as desired.

An interface frame 1123 can allow for modular components in an interface 170 such as in a lean-in glove panel interface, or can allow for modularity of an interface 170 itself for example, in some embodiments, a glove panel interface 170B can be modularly coupled to an interface frame in various locations in walls 130 of a containment chamber 100. For example, in some embodiments a glove panel interface can be modularly configured as a stand-alone interface 170 or can be modularly configured as a part of an interface 170 such as a lean-in glove panel interface 170A.

In some embodiments, an interface frame can provide a permanent coupling such as with a weld, permanent adhesive, or the like. Such couplings can provide a suitable seal as discussed herein. Similarly, while some examples of a containment chamber 100 can have modular elements such as interfaces 170, in further embodiments, such elements can be an integral part of walls 130, or the like, without modularity.

Additionally, the example of a glove panel interface having a pair of gloves should not be construed to be limiting on the wide variety of alternative configurations of interfaces within the scope and spirit of the present disclosure. For example, some embodiments can include an interface 170 having a single glove or any suitable plurality of gloves. Additionally, another embodiment can include an interface having a pair of gloves and an elongated interface unit (e.g., similar to a glove, but without fingers, such as a cylinder) which can be used in some examples can have medical devices, or the like, inserted therein to interface with an isolated patient and to be manipulated by the pair of gloves. Accordingly, the material of such an elongated interface unit can be configured such that medical devices (e.g., stethoscope, thermometer, or the like) can operate through the material (e.g., TPU, PVC, butyl, nitrile, latex, and the like). In various embodiments, gloves can be layered over with sterile surgical gloves and/or the glove subcomponent can be replaced as needed.

Some embodiments of a glove can comprise a cinch assembly configured to make the glove more usable by a user with larger and smaller sized hands. For example, a cinch assembly can comprise a cord (e.g., shock cord) that is held by a plurality of retainers (e.g., tarpaulin patches). A cord lock can be configured to tighten the cord around the wrist and up towards the elbow of the user to adapt the gloves to users with smaller hands or arms.

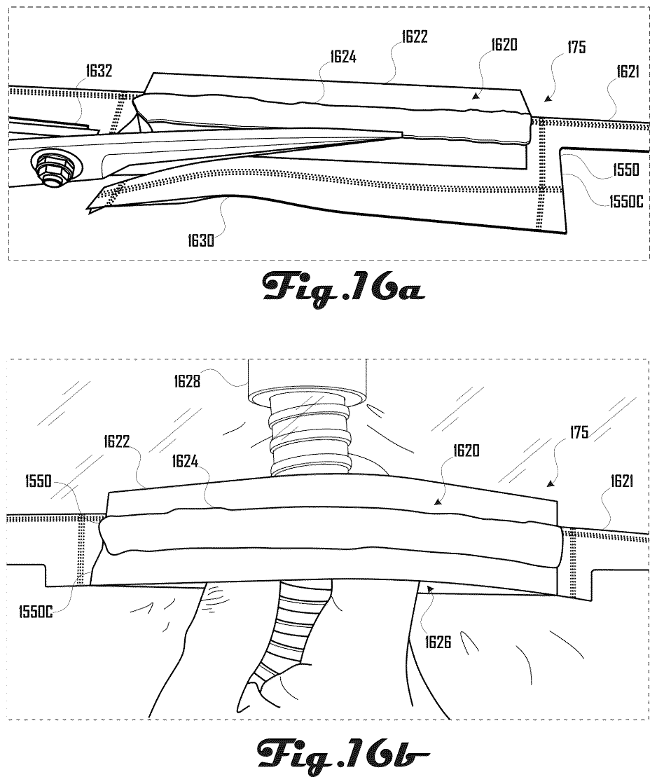

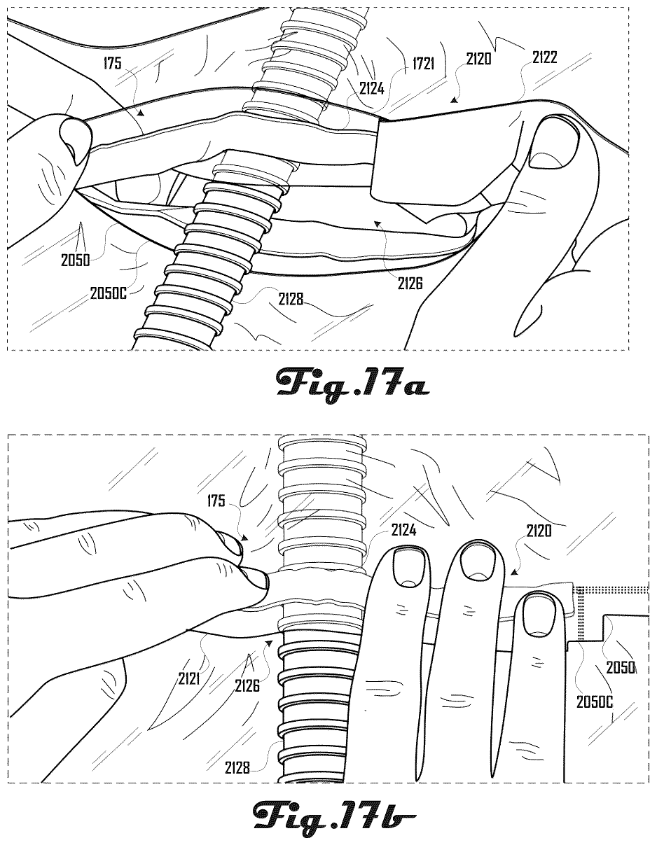

FIG. 15 illustrates the configuration of one embodiment of a pass-through 175 and FIGS. 16a, 16b, 17a and 17b illustrate one embodiment of a pass-through unit 1550. Further embodiments can include one or more pass-throughs 175 in various suitable locations, with various suitable orientations, and with various suitable configurations, so the present examples of pass-throughs 175 should not be construed to be limiting.

Turning to FIG. 15, an example of a pass-through 175 is illustrated having a linear array of pass-through units 1550. Specifically, the pass-through 175 is shown having a one first pass-through unit 1550A and six second pass-through units 1550B. In various embodiments, the pass-through 175 can be coupled to a wall 130 of a containment chamber 100 via a pass-through frame 1570, with the array of pass-through units 1550 extending from the wall 130 on the outside of the containment chamber 100, which can make it possible for a user (e.g., doctor, nurse, or the like) to manipulate the pass-through units 1550 and insert and/or remove elements from the pass-through 175 as discussed in more detail herein. In some examples, the pass-through 175 can be integrally coupled to a wall 130 or modular via pass-through frame 1570, which in some embodiments can allow different pass-throughs 175 to be coupled to the wall 130 via the pass-through frame 1570, a flat plate to be coupled to the wall 130 via the pass-through frame 1570, and the like.

Turning to FIGS. 16a, 16b, 17a and 17b, another embodiment of a pass-through unit 1550C is illustrated that includes a pass-through sheets 1621, a coupling cover 1622, and a coupling 1624 that define a pass-through slot 1626, which in this example, allows a tube 1628 to be inserted through the pass-through unit 1550 and extending between the outside and inside of a wall 130 of the containment chamber 100.

As shown in the example of FIG. 16a, in some embodiments a pass-through unit 1550 can initially be sealed (e.g., via a weld, or the like), and a tip 1630 of the pass-through unit 1550 can be removed (e.g., via scissors 1632), to expose the pass-through slot 1626 defined at least in part by opposing sheets 1621 of the pass-through unit 1550. As shown in FIG. 16b, a tube 1628 (e.g., a ventilator tube) can be inserted through the pass-through slot 1626 (e.g., from the outside of the containment chamber 100 into one of the chambers 150).

To generate a seal around the tube 1628 so that the outside and inside of the containment chamber 100 can remain separate, the coupling cover can be removed from the coupler 1624 as shown in FIG. 16a, which can allow opposing faces of the coupler 1624 to be coupled together on opposing sides of the tube 1628 to generate a seal around the tube 1628 as shown in FIG. 16b. Such a seal can be complete, substantially complete, or sufficiently complete such that any gaps do not allow air to escape from the containment chamber 100 based on a negative pressure within the containment chamber 100. In some embodiments, the coupler 1624, can comprise an adhesive material.

Pass-through units 1550 can be configured in various suitable ways, so the example of FIGS. 16a, 16b, 17a, and 17b should not be construed as being limiting. For example, further embodiments can include various suitable couplers, such as hook and loop tape, magnetic strips, a zip tie, hose clamp, or the like. Additionally, some embodiments of pass-through units 1550 may not include a sealed tip 1630 or may include a re-sealable tip that does not need to be cut to expose the pass-through slot 1626. Similarly, a pass-through 175 can have any suitable number of one or more pass-through units 1550 with a plurality of pass-through units 1550 being the same or different in some embodiments. For example, FIG. 15 illustrates the first pass-through unit 1550A configured with a larger slot 1626 than the second pass-through units 1550B, which can be desirable for allowing a larger sized element (e.g., a ventilation tube) to be introduced into the containment chamber 100 via the first pass-through unit 1550A and smaller sized elements (e.g., IV tubes) can be introduced into the containment chamber 100 via the second pass-through units 1550B.

Various embodiments can include doors 185 that include one or more airlocks configured for items to be introduced into and/or removed from the containment chamber 100. For example, various examples of a containment chamber 100 can include one or more airlocks that comprise an enclosure that defines an airlock cavity, with a pair of airlock doors that respectively provide access to the airlock cavity via the outside and inside of the containment chamber 100. In some embodiments, pass-through 175 can act as an airlock and can include an external zipper and an internal zipper that opens into a central cavity, pocket, or the like.

In some examples, airlocks can extend internally, externally, and/or both internally and externally. For example, in some embodiments, the enclosures of externally extending airlocks, are disposed on the outside of the containment chamber with one airlock door on an external portion of the enclosure and another door airlock 180 in a wall 130 that opens from the chamber 150. Airlocks can be disposed in various suitable locations on a containment chamber 100 for various purposes.

Some embodiments can be configured for rapid deployment via an inflatable architecture 110 can be similar to life raft or inflatable slide for aircraft where a box is placed in the room where the containment chamber 100 is to be deployed and a cord is pulled, inflating the containment chamber 100 with stored gas from a canister. Additionally, various suitable configurations of an architecture 110 can be used in further embodiments, and in some embodiments, an architecture 110 can be absent (e.g., the containment chamber 100 can be self-supported or tied to and supported by external structures such as trees, structural elements of a building, or the like).

FIGS. 1-14 illustrate various example embodiments of the containment chamber 100 (e.g., a patient isolation unit (PIU), patient containment chamber, or the like) in accordance with various embodiments. However, these example embodiments should not be construed to be limiting on the wide variety of different containment chambers 100 that are within the scope and spirit of the present disclosure, including containment chamber 100 that are larger, smaller, more complex, less complex, or the like.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

What is claimed is:

1. A method of using a containment chamber, the method comprising:
assembling the containment chamber from a packed state to an expanded state, the assembling including:
assembling an architecture, the architecture including:
a plurality of vertical poles,
a plurality of top-of-wall beams,
one or more flexible roof support poles, and
a base assembly comprising a plurality of base poles,
wherein assembling the architecture at least includes coupling the one or more flexible roof support poles to one or more of: the plurality of vertical poles and/or the plurality of top-of-wall beams; and
attaching a flexible polymer enclosure to the architecture, the flexible polymer enclosure defining a chamber via a plurality of walls including:
a plurality of end walls,
a plurality of sidewalls,
one or more roof walls,
a plurality of couplings attached to the one or more roof walls, and
a floor wall,
wherein attaching the flexible polymer enclosure to the architecture includes coupling the plurality of couplings to the one or more flexible roof support poles to suspend the plurality of walls and configure the one or more roof walls in the expanded state;
disposing the containment chamber on a mobile unit comprising at least one of a foldable roll-in stretcher and a gurney, with the base assembly and the floor wall being disposed on the at least one of the foldable roll-in stretcher and the gurney;
opening the flexible polymer enclosure via one or more peripheral couplings disposed in at least the plurality of sidewalls and at least one of the plurality of end walls, the opening the flexible polymer enclosure via one or more peripheral couplings generating access to an internal cavity of the chamber defined by the flexible polymer enclosure;
positioning a patient within the open flexible polymer enclosure inside the internal cavity of the chamber, with the patient disposed on or over the at least one of the foldable roll-in stretcher and the gurney, on or over the base assembly, and on or over the floor wall;
sealing the flexible polymer enclosure via the one or more peripheral couplings disposed in at least the plurality of sidewalls and at least one of the plurality of end walls, the sealing causing isolation of the patient within the internal cavity of the chamber defined by the flexible polymer enclosure;
generating a negative pressure within a range of −2.5 to −2.7 Pa within the internal cavity of the chamber defined by the flexible polymer enclosure via an air filtration system;
moving the patient from a first location to a second location via one or more users pushing the at least one of the foldable roll-in stretcher and the gurney;
configuring the one or more roof walls from the expanded state to a collapsed state by:
de-coupling the plurality of couplings from the one or more flexible roof support poles, and
detaching the one or more flexible roof support poles from the architecture,
wherein configuring the one or more roof walls from the expanded state to the collapsed state causes the volume of the internal cavity of the chamber defined by the flexible polymer enclosure to decrease by between 2 and 10 cubic feet and wherein the height of the containment chamber is reduced by between 4 and 24 inches, and
wherein the containment chamber remains operable in both the expanded state in the collapsed state to isolate the patient and to generate the negative pressure within a range of −2.5 to −2.7 Pa within the internal cavity of the chamber defined by the flexible polymer enclosure via the air filtration system; and
moving the patient from the second location to a third location via one or more users pushing the at least one of the foldable roll-in stretcher and the gurney, where moving the patient from the second location to the third location includes moving the patient through a door or opening that the containment chamber on the at least one of the foldable roll-in stretcher and the gurney would be inoperable to fit through in the expanded state, but is operable to fit through in the collapsed state, and while the containment chamber remains operable to isolate the patient and generate the negative pressure within a range of −2.5 to −2.7 Pa while in the collapsed state.

2. The method of claim 1, wherein the door or opening has an internal vertical clearance of at least 72 inches and comprises one or more of:
a door of an Airbus H135 helicopter,
a door of a standard ground ambulance, and
a door of a building.

3. The method of claim 1,
wherein each of the plurality of sidewalls and at least one end wall comprises a plurality of glove interfaces,
wherein at least one of the plurality of sidewalls comprises an elongated interface unit,
wherein each of the plurality of sidewalls comprise a plurality of pass-throughs, and
wherein each of the plurality of sidewalls comprise a plurality of pockets.

4. The method of claim 1,
wherein the plurality of walls define a top portion and a bottom portion defined by the one or more peripheral couplings disposed in at least the plurality of sidewalls and at least one of the plurality of end walls,
wherein the top portion is substantially completely transparent to allow visibility of the patient from all sides of the containment chamber,
and wherein the bottom portion is substantially completely opaque.

5. A method of using a containment chamber, the method comprising:
assembling the containment chamber from a packed state to an expanded state, the assembling including:
assembling an architecture, the architecture including:
a plurality of vertical poles,
a plurality of top-of-wall beams,
one or more flexible roof support poles, and
a base assembly comprising a plurality of base poles; and
attaching a flexible polymer enclosure to the architecture, the flexible polymer enclosure defining a chamber via a plurality of walls including:
a plurality of end walls,
a plurality of sidewalls,
one or more roof walls,
a plurality of couplings attached to the one or more roof walls, and
a floor wall,
wherein attaching the flexible polymer enclosure to the architecture includes coupling the plurality of couplings to the one or more flexible roof support poles to suspend the plurality of walls and configure the one or more roof walls in the expanded state;
disposing the containment chamber on a mobile unit;
opening the flexible polymer enclosure to generate access to an internal cavity of the chamber defined by the flexible polymer enclosure;
positioning a patient within the open flexible polymer enclosure inside the internal cavity of the chamber;
sealing the flexible polymer enclosure to isolate the patient within the internal cavity of the chamber defined by the flexible polymer enclosure;
generating a negative pressure within the internal cavity of the chamber via an air filtration system;
moving the patient from a first location to a second location via one or more users pushing the mobile unit;
configuring the one or more roof walls from the expanded state to a collapsed state by:
de-coupling the plurality of couplings from the one or more flexible roof support poles, and
detaching the one or more flexible roof support poles from the architecture,
wherein configuring the one or more roof walls from the expanded state to the collapsed state causes the volume of the internal cavity of the chamber defined by the flexible polymer enclosure to decrease and causes the height of the containment chamber to be reduced, and
wherein the containment chamber remains operable in both the expanded state in the collapsed state to isolate the patient and to generate the negative pressure within the internal cavity of the chamber via the air filtration system; and
moving the patient from the second location to a third location via one or more users pushing the mobile unit, where moving the patient from the second location to the third location includes moving the patient through a door or opening that the containment chamber on the mobile unit would be inoperable to fit through in the expanded state, but is operable to fit through in the collapsed state, and while the containment chamber remains operable to isolate the patient and generate the negative pressure within the internal cavity of the chamber via the air filtration system, while in the collapsed state.

6. The method of claim 5, wherein assembling the architecture comprises coupling the one or more flexible roof support poles to one or more of the plurality of vertical poles and the plurality of top-of-wall beams.

7. The method of claim 5, wherein the mobile unit comprises at least one of a foldable roll-in stretcher and a gurney, with the base assembly and the floor wall being disposed on the at least one of the foldable roll-in stretcher and the gurney.

8. The method of claim 5, wherein the method further includes opening the flexible polymer enclosure via one or more peripheral couplings disposed in at least the plurality of sidewalls and at least one of the plurality of end walls, the opening the flexible polymer enclosure via one or more peripheral couplings generating access to the internal cavity of the chamber defined by the flexible polymer enclosure.

9. The method of claim 8, wherein the method further includes positioning the patient within the open flexible polymer enclosure inside the internal cavity of the chamber, with the patient disposed on or over the mobile unit, on or over the base assembly, and on or over the floor wall.

10. The method of claim 5, wherein the negative pressure generated via the air filtration system is within a range of −2.5 to −2.7.

11. The method of claim 5, wherein configuring the one or more roof walls from the expanded state to the collapsed state causes the volume of the internal cavity of the chamber defined by the flexible polymer enclosure to decrease by between 2 and 10 cubic feet and wherein the height of the containment chamber is reduced by between 4 and 24 inches.

12. A method of using a containment chamber, the method comprising:
assembling the containment chamber, the assembling the containment chamber including:
assembling an architecture, and
attaching an enclosure to the architecture, the enclosure defining a chamber via a plurality of walls, the attaching causing suspension of the plurality of walls into an expanded state;
disposing the containment chamber on a mobile unit;
disposing a patient in the containment chamber and on the mobile unit;
configuring the containment chamber from the expanded state to a collapsed state; and
moving the patient in the containment chamber from a first location to a second location via the mobile unit, where moving the patient from the first location to the second location includes moving the patient through a door or opening that the containment chamber on the mobile unit would be inoperable to fit through in the expanded state, but is operable to fit through in the collapsed state, and while the containment chamber remains operable to isolate the patient within an internal cavity of the chamber while in the collapsed state.

13. The method of claim 12, wherein the architecture includes:
a plurality of vertical poles,
a plurality of top-of-wall beams,
one or more flexible roof support poles, and
a base assembly comprising a plurality of base poles.

14. The method of claim 12, wherein the enclosure defines a chamber via the plurality of walls including:
a plurality of end walls,
a plurality of sidewalls,
one or more roof walls,
a plurality of couplings attached to the one or more roof walls, and
a floor wall.

15. The method of claim 12, wherein attaching the enclosure to the architecture includes coupling a plurality of couplings to one or more roof support poles of the architecture to suspend the plurality of walls and configure one or more roof walls of the enclosure in the expanded state.

16. The method of claim 12, wherein the method further comprises:
opening the enclosure to generate access to the internal cavity of the chamber defined by the enclosure;
positioning the patient within the open enclosure inside the internal cavity of the chamber; and
sealing the enclosure to isolate the patient within the internal cavity of the chamber defined by the enclosure.

17. The method of claim 12, wherein the method further comprises:
generating a negative pressure within the internal cavity of the chamber via an air filtration system.

18. The method of claim 12, wherein the method further comprises configuring one or more roof walls of the enclosure from the expanded state to the collapsed state by de-coupling a plurality of couplings from the architecture, and
wherein configuring the one or more roof walls from the expanded state to the collapsed state causes the volume of the internal cavity of the chamber defined by the enclosure to decrease and causes the height of the containment chamber to be reduced.

19. The method of claim 12, wherein where moving the patient from the first location to the second location includes moving the patient through a door or opening that the containment chamber on the mobile unit would be inoperable to fit through in the expanded state, but is operable to fit through in the collapsed state, and while the containment chamber remains operable to isolate the patient and operable generate a negative pressure within the internal cavity of the chamber via an air filtration system, while in the collapsed state.
